(19) United States
(12) Patent Application Publication
(10) Pub. No.: US 2002/0073145 A1
(43) Pub. Date: Jun. 13, 2002

(54) System for dynamically generating and processing a program

(76) Inventor: Tadashi Shimoji, Osaka (JP)

Correspondence Address: SMITH PATENT OFFICE, 1901 PENNSYLVANIA AVENUE N W, SUITE 200, WASHINGTON, DC, 20006

(21) Appl. No.: 09/963,783

(22) Filed: Sep. 27, 2001

(30) Foreign Application Priority Data
Oct. 2, 2000 (JP) 2000-302258

(51) Int. Cl. G06F 15/16

(52) U.S. Cl. 709/203

(57) ABSTRACT

In a system for dynamically generating and processing a program, the functional module classes are stored in the client computer or the data processing server computer, while the configuration information is stored in the server computer. When the definition information is input via the client computer, the configuration information is read out and sent to the client computer or the data processing server computer. Also, the functional module classes are read out based on the configuration information. Further, the unit-program processing is dynamically generated and processed. Thereby the desired data processing is performed as a whole.

### BACKGROUND OF THE INVENTION

1. Field of the Invention

The present invention relates to a system for dynamically generating and processing an application program, especially as it relates to the system that enables generating and executing the program of desired data processing by only downloading a small amount of data required for generating and processing the program from a server computer to a client computer.

2. Discussion of the Related Art

When performing some kind of data processing on a personal computer (hereinafter PC), it is known to need installation of a computerizing program into the PC for executing the desired data processing.

There is a conventional method that sets a recordable media such as a compact disk or a floppy disk stored an application program of data processing therein into the PC, loads and installs the program into the PC.

Internet techniques are developing rapidly, as a result, it is also known to connect between the PCs and the server computers via a network means such as Internet, to download and to install an application programs stored in the server computer into the PC.

However, in the conventional method using the recordable media, when updating the program installed in the PC, it is necessary to prepare the recordable media stored the data for updating the program installed in the PC, thus cannot update the program rapidly.

In the conventional method using the network means, it is possible to download the updating program from the server computer to the PC right away, but there is a very troublesome task. That is, when the program size is large, it requires a long time of waiting until completing a download operation, and even if a compressed program is downloaded, it requires 1 or 2 hours of waiting.

Furthermore, in both of conventional methods using the recordable media and the network means, it can only be to execute a standard data processing programmed in advance, and if execution of a desired voluntary data processing is required, it is not easy to execute since it is necessary to perform program coding with knowledge of programming language.

### SUMMARY OF THE INVENTION

It is an object of the present invention to provide a system for dynamically generating and processing an application program that may be generated and executed by only downloading a small amount of data from the server computer to the client computer.

A system for dynamically generating and processing a program by connecting a server computer and at least one of a client computer and a data processing server computer via a network means, sending and receiving data therebetween, and executing a desired voluntary data processing process by dynamically generating and then processing at least one unit-program for data processing, said system comprising:

a functional module storage means for storing a plurality of functional module classes, wherein each of said functional module classes has a coded processing logic for processing at least a portion of the unit-program;

a configuration information storage means for storing a plurality of configuration information including at least request information to read out at least one of the functional module classes and a processing condition;

a definition information input means for inputting at least one definition information to declare the contents of a data processing process to be executed;

a configuration information read-out means for reading out at least one of the configuration information corresponding to said at least one of the definition information from said configuration information storage means;

a unit-program generating means for reading out at least one of the functional module classes corresponding to said at least one of the configuration information from said functional module storage means, wherein said unit-program generating means dynamically generates a unit-program by using the coded processing logic from said functional module classes; and

a unit-program processing means for dynamically executing said unit-program by using said processing condition included in said configuration information.

It is one aspect of the invention that the functional module classes coding a logic of data processing are stored into the client computer or the data processing server computer while the configuration information including the request information of the functional module class are stored into the server computer. When the definition information for to declare contents of data processing are inputted via the client computer, the configuration information corresponding to the definition information are read out by the server computer, and then are sent to the client computer or the data processing server computer via the network means. In the client computer or the data processing server computer, one or the plurality of functional module class(es) is(are) read out based on the configuration information, the unit-program is dynamically generated and one or a plurality of the generated unit-program are sequentially or orderly executed, thereby the desired data processing is performed as a whole.

As a result, a desired voluntary data processing may be performed on the client computer, it is not necessary to code the desired program so that a desired task such as a program updating may be easily accomplished without knowledge of programming language.

Also, when the unit-program dynamic generator, that is the unit-program generating means is provided in the client computer or the data processing server computer, it is not necessary to install or to download any programming data from the server computer to the client computer or the data processing server computer. Thus, traffic stress of network means such as Internet become small, the desired data processing can be started quickly by only sending and receiving the definition information and the configuration information between the server computer and the client computer or the data processing server computer.

The configuration information may be inputted every time that the data processing is executed. However, when once a desired data processing has executed, the configuration information can be stored in the client computer or the data processing server computer at the first processing, and the following identical data processing can be started by using the configuration information thereof, thereby enhancing the operation span of the client computer.

It is preferable to further provide a configuration information request means that requests at least one of the configuration information for executing the data processing, the configuration information storage means for storing the configuration information that have used for generating the unit-program, corresponding to the data processing to be executed, wherein the configuration information read-out means reads out the configuration information from said configuration information storage means based on the request from the configuration information request means.

It is also possible to have inputted the configuration information via an operation terminal computer of server computer or the client computer, and then to have stored one or a plurality of configuration information, which are expected to use, corresponding to each of a plurality of data processing in advance. When there is a request from the client computer, the configuration information corresponding to the request may be sent to the client computer or the data processing server computer, and the unit-program processing can be dynamically generated and then executed on the client computer or the data processing server computer.

A system for dynamically generating and processing a program by connecting a server computer and a client computer via a network means, sending and receiving data therebetween, and executing the desired voluntary data processing process by dynamically generating and processing at least one unit-program for data processing, said system comprising:

a functional module storage means for storing a plurality of functional module classes, wherein each of said functional module classes comprises a coded processing logic for processing at least a portion of the unit-program;

a configuration information storage means for storing a plurality of configuration information corresponding to each of a plurality of data processing processes, wherein said configuration information includes at least request information to read out at least one of the functional module classes and a processing condition;

a configuration information request means for requesting at least one of the configuration information for executing the data processing process;

a configuration information read-out means for reading out at least one of the configuration information from said configuration information storage means corresponding to said request from the configuration information request means;

a unit-program generating means for reading out at least one of the functional module classes corresponding to said at least one of the configuration information from said functional module storage means, wherein said unit-program generating means dynamically generates a unit-program by using the coded processing logic from said functional module classes; and

a unit-program processing means for dynamically executing said unit-program based on said processing condition included in said configuration information.

All of functional module class coded a logic for data processing may be valid for dynamically generating and processing a program, it is preferable, for example, to classify a plurality of different data processing into pattern, to divide the classified data processing into the detailed unit-processing, and then to code a common logic of data processing retrieved from the detailed unit-processing.

Furthermore, it is preferable that the system according to the invention includes at least one functional module class coded the data processing logic handling variable parameter for expanding the flexibility of usage of the unit-processing. At least one functional module class may comprise with a method of handling variable parameter which adds a logic of small program in the basic logic for executing the unit-processing, for example, by coding parameters such as “data name”, “label name”, “item type”, and “data length” by scripts.

It is preferable that the configuration information storage means stores at least one functional module class having a coded processing logic for handling at least one of a variable data and a parameter. The definition information input means inputs at least one of definition information to declare the contents of the data processing process and at least one of the variable data and the parameter. The configuration information read-out means reads out at least one of the configuration information from said configuration information storage means corresponding to said at least one of the definition information and the request from said configuration information request means. The unit-program generating means reads out at least one of the functional module classes including at least one functional module class from said functional module storage means corresponding to said at least one of the configuration information. The unit-program generating means dynamically generates the unit-program by using both the coded processing logic from said functional module classes and said at least one of the variable data and the parameter included in the configuration information.

The definition information are sent and received between the server computer and the client computer, and the unit-program is dynamically generated and then executed, however, since one aspect of the invention is dynamically to generate and to execute the unit-program, it is possible to distribute a program of dynamical generating and executing of unit-program to some other client computers or some other server computers.

Also, when the client computer accesses to the server computer, the server computer may execute some application program processing or batch processing such as an access-processing to the database server computer, selection, updating and/or deletion of data. In this case, the server computer can distribute a part of dynamic generation and execution of the unit-program. Accordingly, “a client computer”, “a data processing server computer” and “a server computer” can also include the means of executing the unit-program generating means and the unit-program processing means in the present invention.

That is, it is preferable that the system for dynamically generating and processing a program comprises a server computer having the configuration information storage means and the configuration information read-out means, and a client computer having the functional module storage means, the unit-program generating means and the unit-program processing means. In this embodiment, the configuration information request means may be built into the client computer.

When the server computer or the data processing server computer dynamically generates and executes the unit-program, it is possible to comprise the system for dynamically generating and processing a program according to the invention by providing at least one of the server computer and the data processing server computer with the functional module storage means, the unit-program generating means and the unit-program processing means. It is also possible that, if necessary, at least one of the server computer and the data processing server computer includes a processing-result output means for sending a result of the unit-program processing to the client computer.

The client computer and the server computer may be comprised by using any kind of a data processing system so long as it is possible to process electric order signals and/or information for performing various calculation and arithmetic processing; however, generally the workstation computer or the PC may be used. The client computer also may be comprised by using a mobile terminal computer such as a palm top computer that uses public domain networks.

Especially, if the client computer is comprised by using the mobile terminal computer, the mobile computer is provided a display of small area, doesn't need a large number of the functional module classes for data processing and can generate a small range of the unit-program, thus the program for controlling the system according to the present invention can become smaller than that of controlling the system using the personal computers.

As a result, in the system comprising the mobile terminal computer, because of above-mentioned reason coupled with a small amount of data sent and received between the server computer and the mobile terminal computer, it is possible to process the desired program processing smoothly under a run time environment which the mobile computer has the limited capacity of memory and Internet is used as the network means.

The network means may comprise a means that is able to send and receive the information and the electric order signals between a main data processing system and a user side data processing system. For example, it is possible to adopt the networks such as LAN (Local Area Network), Internet or a public telephone network.

When the dynamic generating and the dynamic executing of the unit-program are distributed to a plurality of computers as mentioned above, it is possible to distribute a part of the dynamic generating and executing of the unit-program to the server computer, and to send a result of processing thereon to the client computer. Especially, when providing a part of the distributed data processing to at least one of the server computer and the data processing server computer, the data processing of the system can become high speed as a whole because a traffic stress of the client computer can become minimized and an ability of the server computer and the data processing server computer are larger than that of the client computer.

It is possible to comprise the server computer with the configuration information storage means, the unit-program generating means, the unit-program processing means and the processing result output means which outputs an executed result of the unit-program to at least one of the client computer and the data processing server.

The definition information includes information to declare the contents of a data processing process to be executed, for example, number and types of functional module class, combinations of functional module class and executing order of functional module class required for specific data processing. However, when inputting the specific functional module classes to the client computer, the request information of functional module classes must be prepared in advance as a list relating with, for example, the names or the function of functional module classes, and there is a risk of the complicated input-operation.

Accordingly, it is preferable to input contents of detailed data processing into the client computer, to analyze said contents on the server computer, the client computer or the data processing server computer, to decide number and types of the functional module classes, combination and the executing orders of the functional module classes required for executing the data processing. And then the definition information including said information relating the functional module classes may be sent to the client computer, the client computer reads out the functional module classes, generates and executes the unit-program dynamically, whereby the structure of the definition information and the input operation of the client computer may be simple.

That is, it is preferable that the definition information includes information relating to the number of functional module class, types of functional module class, a combination of the functional module classes and a processing order of the functional module classes for executing the data processing process.

Generally, some kinds of information and order commands are inputted into the client computer by using the display thereof and the result of processing is indicated on the display thereof. Therefore, the client computer comprising the system for dynamical generating and processing data according to the invention would be provided with a display means that indicates the necessary information, the results inputted and the results of data processing.

There are two types of the input operation on the client computer, one of them is a type of CGI (Command User Interface), wherein the character strings as the commands are inputted into the client computer and the results of processing are returned as the data of character strings. Another of them is a type of GUI (Graphical User Interface), wherein the orders to the client computer are inputted into the client computer by putting a pointer of mouse on the desired icon in the window of the display area, and clicking, dragging and dropping the mouse of the client computer. In the system according to the invention, either of said two types may be employed, however, the later, the type of GUI, is preferable for the beginners of operating a computer because of easier operating thereof.

According to the invention, there is provided at least one of the client computer and the server computer comprising the system for dynamical generating and processing data according to the invention.

That is, a client computer in a system for dynamically generating and processing a program by connecting to a server computer via a network means, sending and receiving data therebetween and executing a desired voluntary data processing process by dynamically generating and then processing at least one unit-program for data processing, said client computer comprising:

a functional module storage means for storing at least one functional module class, wherein each of the functional module classes has a coded processing logic for processing at least a portion of the unit-program;

a definition information input means for inputting at least one definition information to declare the contents of a data processing to be executed;

a unit-program generating means for reading out at least one of said functional module classes from said functional module storage means, corresponding to at least one of the configuration information, and then generating a unit-program by using the coded processing logic from said functional module classes, wherein said configuration information is sent from the server computer and includes at least request information to read out at least one of said functional module classes and a processing condition; and

a unit-program processing means for dynamically executing said unit-program by using said processing condition included in said at least one of the configuration information.

In this embodiment, when the server computer stores the configuration information used to generate the unit-program corresponding to the data processing to be executed, it is preferable that the client computer comprises a configuration information request means for requesting at least one of the configuration information corresponding to the data processing to be executed.

A client computer in a system for dynamically generating and processing a program by connecting with the server computer via a network means, sending and receiving data therebetween, and executing a desired voluntary data processing process by dynamically generating and then processing at least one unit-program for data processing, said client computer comprising:

a functional module storage means for storing a plurality of functional module classes, wherein each of said functional module classes comprises a coded processing logic for processing at least a portion of the unit-program;

a configuration information request means for requesting configuration information to be sent to the client computer corresponding to the data processing to be executed;

a unit-program generating means for reading out at least one of said functional module classes corresponding to at least one of the configuration information from said functional module storage means when said configuration information including at least read-out information of said functional module class and a processing condition are sent from said server computer based on said request, and then generating the unit-program by using the coded processing logic from said functional module classes; and

a unit-program processing means for dynamically executing said unit-program based on said processing condition included in said configuration information.

In said client computer, it is preferable that the functional module storage means stores at least one functional module class having a coded processing logic for handling at least one of a variable parameter. The definition information input means inputs at least one definition information which declares the contents of data processing process to be executed and includes a variable parameter. The configuration information read-out means reads out at least one configuration information corresponding to said at least one of definition information or corresponding to a request of the configuration information request means from the configuration information storage means. The unit-program generating means reads out at least one of said functional module classes corresponding to at least one of the configuration information from the functional module storage means. And then the unit-program generating means dynamically generates the unit-program by using both the coded processing logic from said at least one functional module class and said at least one of the variable parameter included in the configuration information.

A server computer in a system for dynamically generating and processing a program by connecting to at least one of a client computer and a data processing server computer via a network means, sending and receiving the data there between, and making at least one of the client computer and the data processing server computer execute the desired voluntary data processing process by dynamically generating and processing at least one unit-program for data processing, said server computer comprising:

a configuration information storage means for storing a plurality of configuration information including at least request information to read out at least one functional module class and a processing condition, wherein each of the functional module classes comprises a coded processing logic for processing at least a portion of the unit-program; and

a configuration information read-out means for reading out at least one of configuration information corresponding to a request which corresponds to a data processing to be executed from a configuration information storage means when said request to read out the configuration information is sent from the client computer, sending and providing said read-out configuration information to at least one of the client computer and the data processing server computer,

whereby at least one of the client computer and the data processing server computer dynamically generates and processes said unit-program based on a processing condition included in the configuration information.

A server computer in a system for dynamical generating and processing data according to the invention also comprise at least one of a client computer and a data processing server computer via a network means, sending and receiving data there between, and making at least one of the client computer and the data processing server computer execute a desired voluntary data processing process by dynamically generating and processing at least one unit-program for data processing, said server computer comprising:

a configuration information storage means for storing a plurality of configuration information including at least request information to send at least one functional module class thereto and a processing condition, wherein each of the configuration information comprises the coded processing logic for processing at least a portion of the unit-program processing;

a configuration information read-out means for reading out at least one of the configuration information based on a request for sending the configuration information thereto from said configuration information storage means when said request for sending the configuration information which corresponds to the data processing process to be executed is sent from the client computer, sending and providing said read-out configuration information to at least one of the client computer and the data processing server computer,

whereby at least one of the client computer and the data processing server computer dynamically generates and processes at least one of said unit-program based on a processing condition included in said configuration information.

In said server computer, it is also preferable to further comprise with the functional module storage means for storing at least one functional module class having a coded processing logic, the unit-program generating means for reading out at least one of said functional module classes corresponding to the configuration information from said functional module storage means when said definition information relating to the data processing to be executed is sent from the client computer wherein said configuration information read out corresponding to the definition information, and dynamically generating the unit5 program by using the coded processing logic from said functional module classes, the unit-program processing means for dynamically executing at least one unit-program based on said processing condition included in said configuration information, and a processing result output means for outputting the executed result of the unit-program to at least one of the client computer and the data processing server.

The functional module storage means and the configuration information storage means may comprise a storage means such as a hard disk driver (HDD) known to person having ordinary skill. Also, the definition information input means, the configuration information output means, the unit-program generating means, the unit-program processing means and the processing result output means also may comprise by using for example a micro processing unit (MPU) or a central processing unit (CPU).

Also, according to the invention, there is provided a method for dynamically generating and processing a program by connecting a server computer and at least one of a client computer and a data processing server computer via a network means, sending and receiving data therebetween, and executing a desired voluntary data processing process by dynamically generating and processing at least one unit-program for data processing in at least one of the client computer and the data processing server computer, said method comprising the steps of:

storing a plurality of functional module classes into a functional module storage means and storing a plurality of configuration information into a configuration information storage means, wherein each of said functional module classes comprises a coded processing logic for processing at least a portion of a unit-program processing and said configuration information includes at least request information to read out at least one of the functional module classes and a processing condition;

inputting at least one definition information to declare the contents of a data processing to be executed via a definition information input means;

reading out at least one of the configuration information corresponding to said at least one of the definition information from said configuration information storage means via a configuration information read-out means;

reading out at least one of the functional module classes corresponding to said at least one of the configuration information from said functional module storage means via a unit-program generating means, and dynamically generating the unit-program processing by using the coded processing logic from said functional module classes via said unit-program generating means; and

dynamically executing said unit-program of the data processing based on the processing condition included in said configuration information via a unit-program processing means.

In said method for dynamical generating and processing data, it is preferable to further provide the steps of:

storing the configuration information corresponding to the data processing to be executed into said configuration information storage means wherein said configuration information is used for generating the data of the unit-program,

requesting at least one of the configuration information for executing the data processing via a configuration information request means, and

reading out the configuration information from said configuration information storage means based on the request of said configuration information request means via the configuration information read-out means.

Also, according to the invention, there is provided a method for dynamically generating and processing a program by connecting a server computer and at least one of a client computer and a data processing server computer via a network means, sending and receiving data therebetween, and executing a desired voluntary data processing process by dynamically generating and processing at least one unit-program for data processing in at least one of the client computer and the data processing server computer, said method comprising the steps of:

storing a plurality of functional module classes into a functional module storage means and storing a plurality of configuration information into a configuration information storage means, wherein each of said functional module classes comprises a coded processing logic for processing at least a portion of a unit-program and said configuration information includes at least request information to read out at least one of said functional module classes and a processing condition;

sending the configuration information corresponding to contents of a data processing to be executed via a configuration information request means;

reading out at least one of the configuration information corresponding to said request from said configuration information storage means via a configuration information read-out means;

reading out at least one of said functional module classes corresponding to said at least one of configuration information from said functional module storage means via a unit-program generating means, and dynamically generating the unit-program processing by using the coded processing logic of said functional module classes via said unit-program generating means; and dynamically executing said unit-program processing based on the processing condition included in said configuration information via a unit-program processing means.

It is also possible to comprise the system for dynamically generating and processing a program according to the invention by installing the program into at least one of a server computer and a client computer via a recordable media that is computer-readable.

According to the invention, there is provided a computer-readable and recordable media for controlling at least one of a client computer and a data processing server computer comprising a system for dynamically generating and processing a program by connecting a server computer and at least one of the client computer and the data processing server computer via a network means, sending and receiving data therebetween, and executing a desired voluntary data processing process by dynamically generating and processing at least one unit-program for data processing in at least one of the client computer and the data processing server computer, said media comprising:

a controlling program for storing a plurality of functional module classes having a coded processing logic;

a controlling program for reading out at least one of said functional module classes and for dynamically generating a unit-program processing by using the coded processing logic of said functional module classes; and

a controlling program for dynamically executing said unit-program processing based on a processing condition included in said configuration information.

Also according to the invention, there is provided a computer-readable and-recordable media for controlling at least one of a client computer and a data processing server computer comprising a system for dynamically generating and processing a program by connecting a server computer and at least one of the client computer and the data processing server computer via a network means, sending and receiving data therebetween, and executing a desired voluntary data processing process by dynamically generating and processing at least one unit-program for data processing in at least one of the client computer and the data processing server computer, said media comprising:

a controlling program for storing a plurality of configuration information including at least one functional module read-out information and a processing condition, wherein a plurality of functional module classes code a logic of a data processing process to be executed;

a controlling program for reading out the configuration information and for sending the read-out configuration information to at least one of the client computer and the data processing server computer when definition information to declare the contents of the data processing process to be executed is sent from the client computer;

a controlling program for storing the configuration information including a read-out information for reading out said functional module classes that code the logic of the data processing; and

a controlling program for reading out the configuration information and for sending the read-out configuration information to at least one of the client computer and the data processing server computer when the definition information to declare the contents of the data processing process to be executed are sent from the client computer.

In said media for controlling the server computer, it is possible to further comprise a controlling program for storing at least one of configuration information corresponding to the data processing to be executed, said configuration information is used for generating a unit-program processing, and a controlling program for reading out at least one of the configuration information based on request information for reading out the configuration information corresponding to the data processing to be executed when said request is sent from the client computer.

According to the invention, there is provided a computer-readable and-recordable media for controlling at least one of a client computer and a data processing server computer comprising a system for dynamically generating and processing a program by connecting a server computer and at least one of the client computer and the data processing server computer via a network means, sending and receiving data therebetween, and executing a desired voluntary data processing process by dynamically generating and processing at least one unit-program for data processing in at least one of the client computer and the data processing server computer, said media comprising:

a controlling program for storing a plurality of functional module classes having a coded process logic;

a controlling program for outputting a request of the configuration information corresponding to a data processing to be executed;

a controlling program for reading out at least one of said functional module classes and for dynamically generating a unit-program processing by using the coded processing logic of said functional module classes when the configuration information including at least functional module read-out information and a processing condition are sent from said server computer; and

a controlling program for dynamically executing said unit-program of data processing based on the processing condition included in said configuration information.

According to the invention, there is provided a computer-readable and-recordable media for controlling a server computer comprising a system for dynamically generating and processing a program by connecting a server computer and at least one of the client computer and the data processing server computer via a network means, sending and receiving data therebetween, and executing a desired voluntary data processing process by dynamically generating and processing at least one unit-program for data processing in at least one of the client computer and the data processing server computer, said media comprising:

a controlling program for storing configuration information including at least functional module read-out information corresponding to a data processing and a processing condition, wherein a plurality of functional module classes code a logic of the data processing; and

a controlling program for reading out the configuration information and for sending the read-out configuration information to at least one of the client computer and the data processing server computer when a request for the configuration information corresponding to the data processing to be executed are sent from the client computer.

Furthermore, it is possible to comprise the client computer or the data processing server computer in a system for dynamically generating and processing a program according to the invention by storing the controlling program, that controls the client computer or the data processing server computer, into the server computer or the other data processing system, and by downloading said controlling program to the client computer or the data processing server computer.

A program transfer system for transferring and downloading a controlling program to at least one of a client computer and a data processing server computer comprising a system for dynamically generating and processing a program by connecting a server computer and at least one of the client computer and the data processing server computer via a network means, sending and receiving data therebetween, and executing a desired voluntary data processing process, said program transfer system comprising:

a program storage means for storing a controlling program for storing a plurality of functional module classes having a coded processing logic, a controlling program for reading out at least one of said functional module classes when definition information is provided to the server computer and the configuration information including at least functional module read-out information to declare the contents of a data processing process to be executed and a processing condition are sent from the server computer, and for dynamically generating a unit-program processing by using the coded processing logic of said functional module classes, and a controlling program for dynamically executing said unit-program of data processing based on the processing condition included in said configuration information;

a program read-out means for reading out the controlling program from said program storage means based on a request from at least one of the client computer and the data processing server computer; and

a transfer means for transferring said read-out controlling program to at least one of the client computer and the data processing server computer.

In said program transfer system, said program storage means may store a controlling program which stores at least one of the configuration information corresponding to the data processing to be executed, said configuration information is used for generating the unit-program processing, and reads out at least one of the configuration information based on a request for reading out the configuration information corresponding to the data processing to be executed when said request is sent from the client computer.

Also according to the invention, there is provided a program transfer system for transferring and downloading a controlling program to at least one of a client computer and a data processing server computer comprising a system for dynamically generating and processing a program by connecting a server computer and at least one of the client computer and the data processing server computer via a network means, sending and receiving data therebetween, and executing a desired voluntary data processing process, said program transfer system comprising:

a program storage means for storing a controlling program for storing a plurality of functional module classes having a coded processing logic, a controlling program for outputting a request for at least one of configuration information corresponding to a data processing to be executed, a controlling program for reading out at least one of said functional module classes when the configuration information including at least functional module read-out information and a processing condition are sent from the server computer and for dynamically generating a unit-program processing by using the coded processing logic of said functional module classes, and a controlling program for dynamically executing said unit-program processing based on the processing condition included in said configuration information;

a program read-out means for reading out the controlling program from said program storage means based on a request from at least one of the client computer and the data processing server computer; and

a transfer means for transferring said read-out controlling program to at least one of the client computer and the data processing server computer via the network means.

The program transfer system may be comprised by using the server computer which provides the configuration information to the client computer or the data processing server computer, but it is possible to comprise said program transfer system by using other server computer.

The program storage means, the program read-out means and the transfer means are preferably provided into the server, but said transfer means may be divided as a plurality of functional parts, and may be provided to the server computer and the client computer or the data processing server computer.

### BRIEF DESCRIPTION OF THE DRAWINGS

The above and other objects and features of the present invention will be clearly understood from the following description with respect to the preferred embodiment thereof when considered in conjunction with the accompanying drawings and diagrams, in which:

FIG. 1 shows an outline configuration of a preferred embodiment of the system for dynamically generating and processing program data according to the present invention;

FIG. 2 shows an example of a basic hardware configuration for the server computer and the client computer according to the present invention;

FIG. 3 shows functional block diagram according to the present invention;

FIG. 4 shows a schematic diagram of the data controlling and processing systems according to the present invention;

FIG. 5 is a flow chart showing the first half of the data control processing system according to the present invention;

FIG. 6 is a flow chart showing the second half of the data control processing system according to the present invention;

FIG. 7 through FIG. 16 show an example of the definition information of the graphical input interface displayed on the client computer according to the present invention;

FIG. 17 through FIG. 29 show an example of the definition information according to the present invention;

FIG. 30 through FIG. 32 show an example of the display area according to the present invention.

### DETAILED DESCRIPTION OF THE PREFERRED EMBODIMENTS

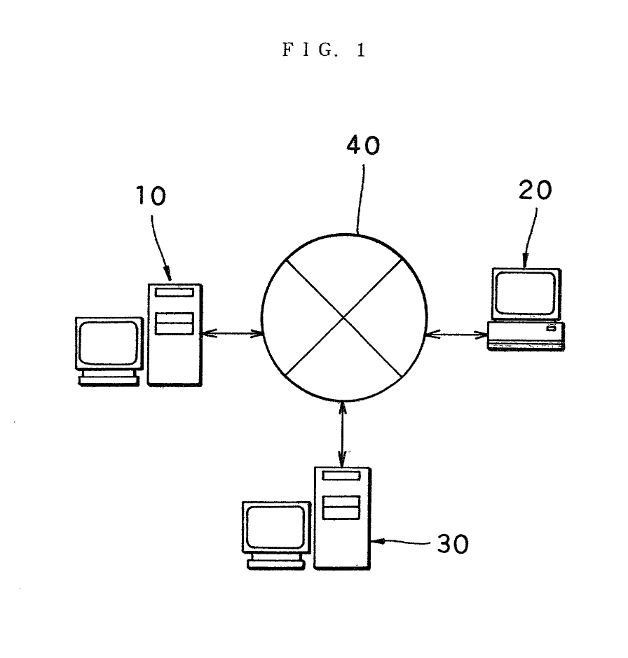

Referring now to the drawings, preferred embodiments of the present invention will be described in detail hereinafter. FIG. 1 through FIG. 4 show preferred embodiments of the system for dynamically generating and processing an application program according to the invention. In FIG. 1, the system comprises a server computer 10, a client computer 20, a data processing server computer 30 and a network 40 such as the Internet which connects between the server computer 10, the client computer 20 and the data processing server computer 30. FIG. 1 shows one server computer 10, one client computer 20 and one data processing server computer 30, but a plurality of server computers 10, client computers 20 and data processing server computers 30 may be provided in the system.

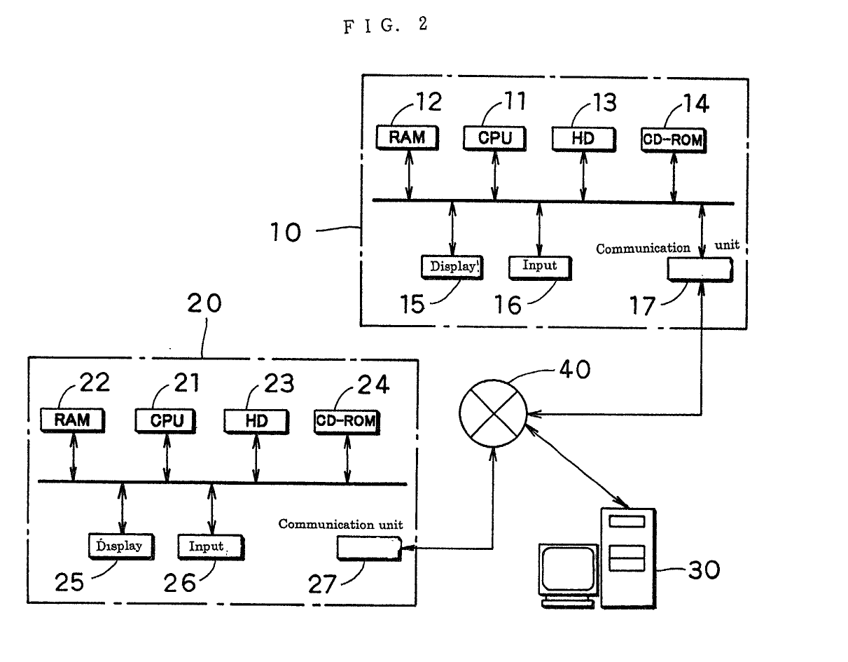

FIG. 2 shows an example of basic hardware configuration of server computer 10 and client computer 20. In FIG. 2, the server computer 10 comprises with a CPU 11, a RAM 12, a HD DRIVER 13, a CD-ROM DRIVER 14, a display such as a CRT 15, an input means such as a keyboard or a mouse 16, a communication means such as a LAN board or a modem 17.

On the hard disk driven by the HD DRIVER 13 is stored a plurality of functional module classes and a plurality of configuration information including information relating to the functional module classes, for example, “request information of functional module classes”, “the number of functional module classes”, “combination of functional module classes”, “executing order of functional module classes”, “executing timing of functional module classes”, and further, “data name”, “label name”, “item type”, “data type” and “data length” handled by the functional module classes, and scripts to add parameters or data input by the client computer to variable data. On the hard disk also are stored controlling programs for performing a dynamic data processing and a data transfer processing in the server computer 10.

Also, when sending a connecting request from the client computer 20, the CPU 11 identifies identity permission by using a user ID and a password sent from the client computer 20. When inputting definition information required for executing the data processing via the client computer 20, or when sending a request for the configuration information if said configuration information used to generate a unit-program already stored, the CPU 11 reads out orderly or one after another the configuration information corresponding to the definition information or the request for the configuration information, sends the configuration information to the client computer 20 or the data processing server computer 30, and stores one or a plurality of the configuration information used for generating the unit-program corresponding to the data processing on the hard disk.

Furthermore, when sending a request from the client computer 20, the CPU 11 reads out one or a plurality of functional module classes corresponding to the configuration information, dynamically generates and processes the unit-program, and then sends the data processing resultant value to the client computer 20.

The client computer 20 basically has the same hardware configuration as that of the server computer 10, that is, it comprises a CPU 21, a RAM 22, a HD DRIVER 23, a CD-ROM DRIVER 24, a display such as a CRT 25, an input means such as a keyboard or a mouse 26 and a communication means such as a LAN board or a modem 27.

The hard disk driven by HD DRIVER 23 stores a controlling program for performing a dynamic data processing in the client computer 20, and further stores a plurality of functional module classes having a coded processing logic, for example, a plurality of function classes, a plurality of fundamental classes, and a plurality of business rule classes, wherein said plurality of functional module classes include at least one functional module class handling variable data or parameters.

Now, in view of the pattern, a plurality of data processing sequences in the business application may be classified several tens of patterns. In the present system, said classified patterns are stored as function classes. For example, in the data processing sequence such as a data batch processing sequence, there are patterns for selecting data from databases and outputting data to a text file, for performing a processing process toward the text file retrieved from the database, for controlling said processing process with quantity of control break processing, and for merge-processing the text file.

Also, with respect to the function class, the function class alone cannot execute the data processing. Therefore, by installing the fundamental classes which react specifically (and also abstractly), it is possible to execute the unit-program. In the present system, a plurality of reactions requested by the general business application are stored as classes. That is, fundamental classes are a kind of functional module classes reacting at a level which the operator is unaware of the reaction when inputting the definition information via client computer 20. For example, with respect to the processing process to access the databases, there are fundamental classes for inserting data to the databases, for updating data in the databases, for selecting data from the databases, and for deleting data from the databases.

It is possible to execute the basic data processing process by a combination of one or a plurality of the function classes and one or a plurality of the fundamental classes, but an actual data processing such as a data processing for calculating each of plurality of data or for handling the special data is executed by further using one or a plurality of business rule class with a combination of the function classes and the fundamental classes. In the present system, a plurality of the business rule classes for executing the actual data processing such as the calculation data processing are stored in advance. For example, with respect to the business rule classes generally stored, there are a plurality of classes for performing each arithmetic calculation, for performing a special calculation process such as a calculating square root, for performing the process calculating a max value, a minimum value or an average value, for performing a processing process to decide a table, and a plurality of logical classes for executing a condition processing and a divergence processing such as “if-then-else” processing. However, when the unit-program cannot be generated by using said business rule classes normally stored, one or a plurality of the classes, that is, the functional module classes, for generating said unit-program must be program-coded.

Also, when the definition information to declare the contents of a desired data processing is inputted, or when a request for the configuration information corresponding to the kind of data processing is selected, the CPU 20 sends said definition information or said request to the server computer 10. Then, when the configuration information sent from the server computer 10 is received, the CPU 21 reads out the functional module classes corresponding to the configuration information, dynamically generates the unit-program by using one or a plurality of the functional module classes, and executes one or a plurality of unit-program.

The data processing server computer 30 has the same hardware configuration as that of the server computer 10. The hard disk driven by a HD DRIVER thereof stores a controlling program for performing a dynamic data processing in the data processing server computer 30, and further stores a plurality of functional module classes having a coded processing logic, for example, a plurality of function classes, a plurality of fundamental classes, and a plurality of business rule classes, wherein said functional module classes include at least one functional module class handling variable data or parameters.

Also, when the configuration information is received, the CPU of the data processing server computer 30 reads out the functional module classes corresponding to the configuration information, dynamically generates a unit-program by using one or a plurality of the functional module classes, and executes one or a plurality of unit-program.

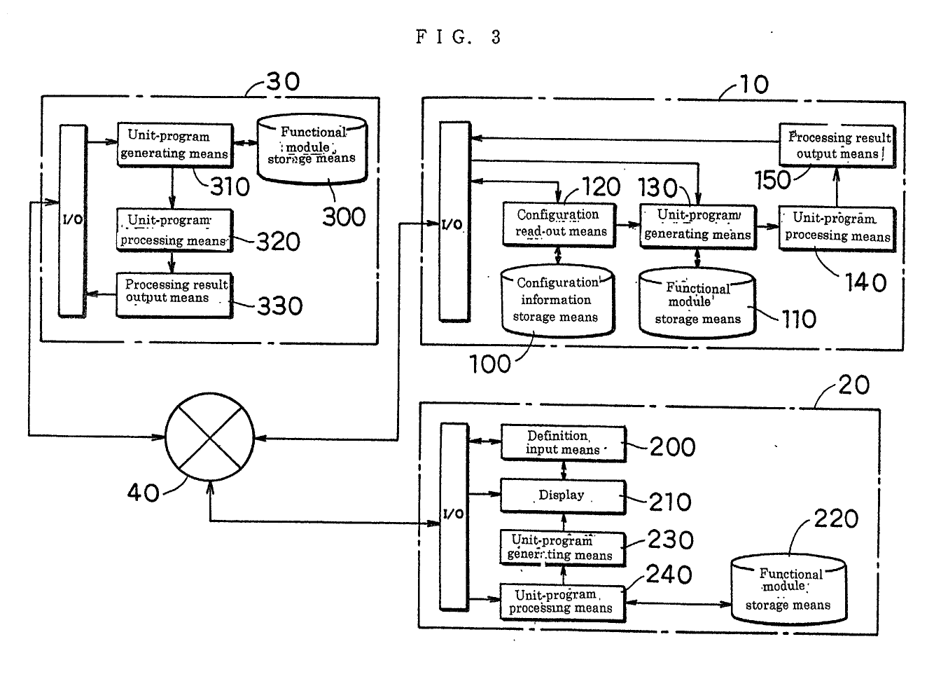

FIG. 3 shows a functional block diagram of the present system for dynamically generating and processing an application program. The server computer 10 functionally comprises a configuration information storage means 100, a functional module storage means 110, a configuration information read-out means 120, a unit-program generating means 130, a unit-program processing means 140 and a processing result output means 150.

The configuration information storage means 100 is a functional means, which comprises the HD DRIVER 13 or other storage means, for storing a plurality of configuration information corresponding to definition information, wherein said configuration information includes read-out information of the functional module classes.

The function module storage means 110 is a function means, which comprises the HD DRIVER 13 or other storage means, for storing a plurality of functional module classes.

The configuration information read-out means 120 is a function means, which comprises the CPU 11, for reading out the configuration information corresponding to the definition information or a request for the configuration information sent from the client computer 20, and outputting said configuration information to the client computer 20 or the data processing server computer 30.

The unit-program generating means 130 is a function means, which comprises the CPU 11, for reading out the functional module classes corresponding to the configuration information when sending a request from the client computer 20, and then dynamically generates a unit-program processing by using one or a plurality of the functional module classes.

The unit-program processing means 140 is a function means, which comprises the CPU 11, for dynamically executing one or a plurality of the generated unit-program processing.

The processing result output means 150 is a function means, which comprises the CPU 11 and the communication means 17, for returning a result value of an execution of the unit-program.

The client computer 20 functionally comprises a definition information input means 200, a display means 210, a functional module storage means 220, a unit-program generating means 230 and a unit-program processing means 240, and further includes a configuration information request means (not shown in FIG. 3).

The definition information input means 200 is a function means, which comprises the CPU 21 and the input means 27, for inputting the definition information and other information via the client computer 20.

The display means 210 is a function means, which comprises the CPU 21 and the display 25, for displaying various information.

The function module storage means 220 is a function means, which comprises the HD DRIVER 23 or other storage means, for storing a plurality of functional module classes.

The unit-program generating means 230 is a function means, which comprises the CPU 21, for reading out the functional module classes corresponding to the configuration information sent from the server computer 10, and then dynamically generating a unit-program by using one or a plurality of the functional module classes.

The unit-program processing means 240 is a function means, which comprises the CPU 11, for dynamically executing one or a plurality of unit-program processing.

The data processing server computer 30 functionally comprises a functional module storage means 300, a unit-program generating means 310, a unit-program processing means 320 and a processing result output means 330.

The function module storage means 300 is a function means, which comprises the HD DRIVER or other storage means, for storing a plurality of functional module classes.

The unit-program generating means 310 is a function means, which comprises the CPU, for reading out the functional module classes corresponding to the configuration information sent from the server computer 10, and then dynamically generating a unit-program by using one or a plurality of the functional module classes.

The unit-program processing means 320 is a function means, which comprises the CPU, for dynamically executing one or a plurality of the generated unit-program processing.

The processing result output means 330 is a function means, which comprises the CPU and the communication means, for returning a result value of an execution of the unit-program.

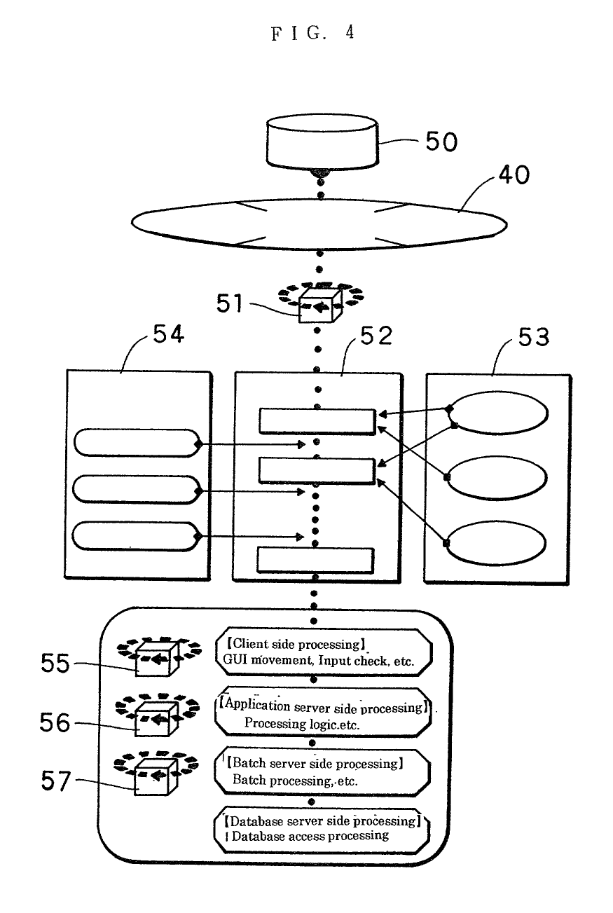

Then, a method of processing in the system for dynamically generating and processing a program is explained with reference to FIG. 4. FIG. 4 shows a concept of data controlling and processing in the system for dynamically generating and processing a program. For example, a controlling program for controlling the system is stored in a CD-ROM as compressed data, and said CD-ROM may be inserted into the CD-ROM Driver 14 and 24 of server computer 10 and the client computer 20 or the data processing server computer 30. When an operator inputs commands, the installing program in the CD-ROM is executed, a program software is read out from the CD-ROM and is loaded to the hard disk in the server computer 10 and the client computer 20 or the data processing server computer 30 as executable data. And when an operator inputs commands for executing the controlling program, a part of or a whole of the program loaded on the hard disk is read out from the hard disk, and is executed by the CPU 11, 21.

Also, in the present system, a transfer program is installed in the server computer 10, wherein said transfer program is for downloading the controlling program, which controls the system for dynamically generating and processing a program, into the client computer 20 and/or the data processing server computer 30. When a request for the controlling program is sent via the client computer 20 and/or the data processing server computer 30, the compressed controlling program is sent to the hard disk in the client computer 20 and/or the data processing server computer 30 via the networks 40, and is downloaded as executable data.

Now, when definition information is inputted or the request for the configuration information is selected via the client computer 20, the configuration information is read out from a repository 50, which functionally comprises the configuration information storage means 100 and the configuration information read-out means 120, and is sent to the client computer 20 or the data processing server computer 30 via the networks 40.

In the client computer 20 or the data processing server computer 30, a dynamic program generator module 51, which functionally comprises the unit-program generating means 130 or 320, automatically reads out the functional module classes, for example, the function classes 52 and fundamental classes 53, if necessary, business rule classes 54, and then dynamically generates the unit-program to combine said functional module classes. Further, in the client computer 20 or the data processing server computer 30, at least one of executing engines 55-57, which functionally comprises with the unit-program processing means 140 or 320, executes one or a plurality of the generated unit-program orderly or one after another, thus a desired data processing is executed as a whole.

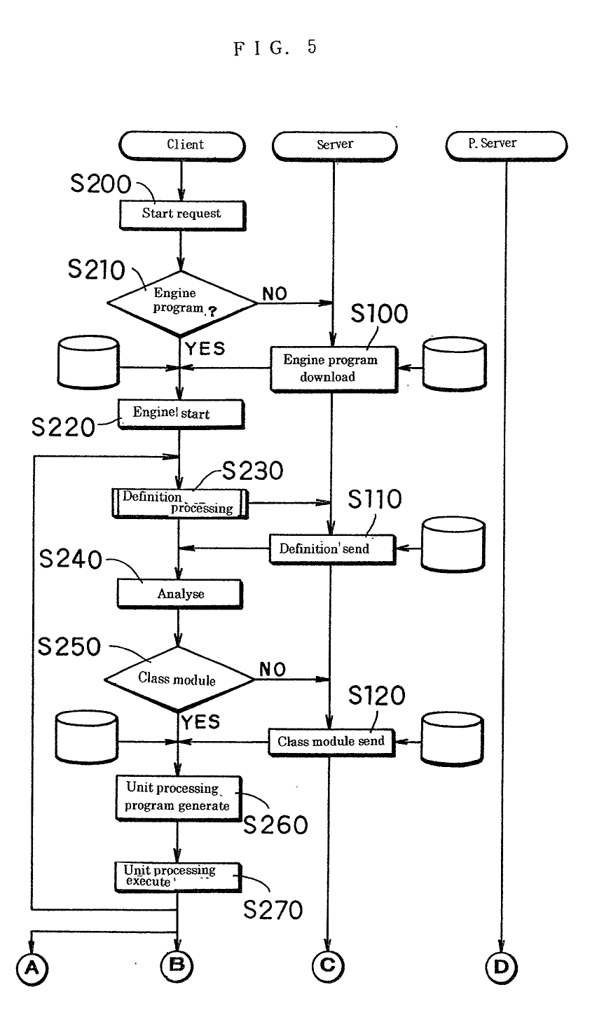

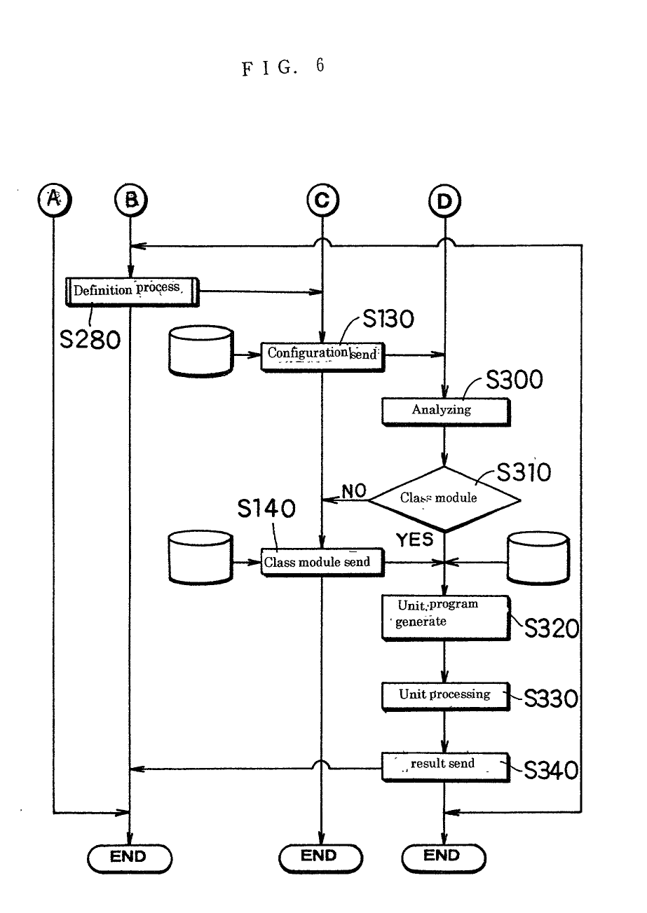

FIG. 5 and FIG. 6 show flow charts of data controlling and processing in the system for dynamically generating and processing a program according to the present invention. When a user desires to perform the desired data processing, the client computer 20 is started, an URL (Uniform Resource Locator) of the server computer 10 is inputted or selected, and the client computer 20 is connected to the server computer 10. Then, when providing a request for starting the controlling programs for performing a dynamic data processing (hereinafter said engine program), it is judged whether the engine program is loaded in the client computer 20 or not (see step S210), and if not loaded, a request for downloading is sent toward the server computer 10, and the engine program is downloaded to the client computer 20 from the server computer 10 (see step S100).

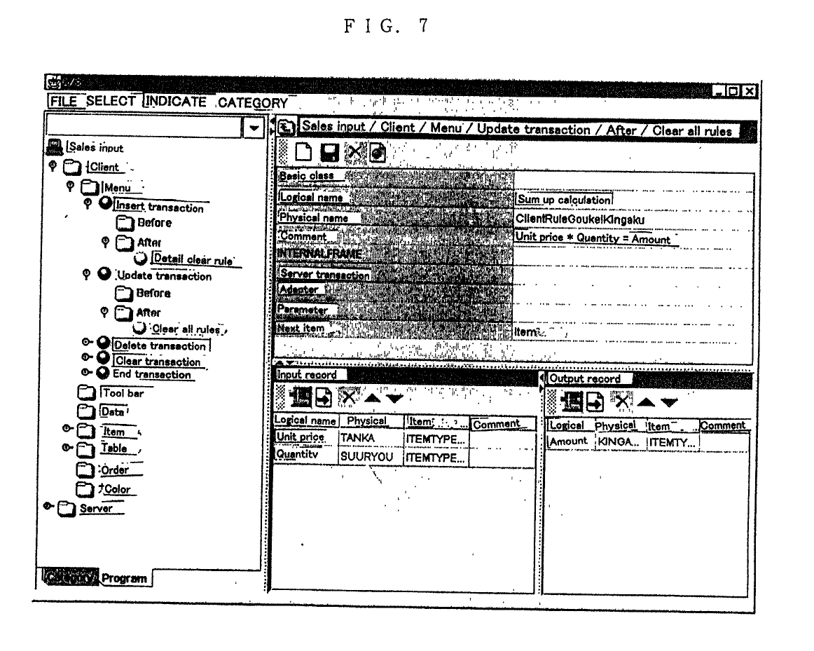

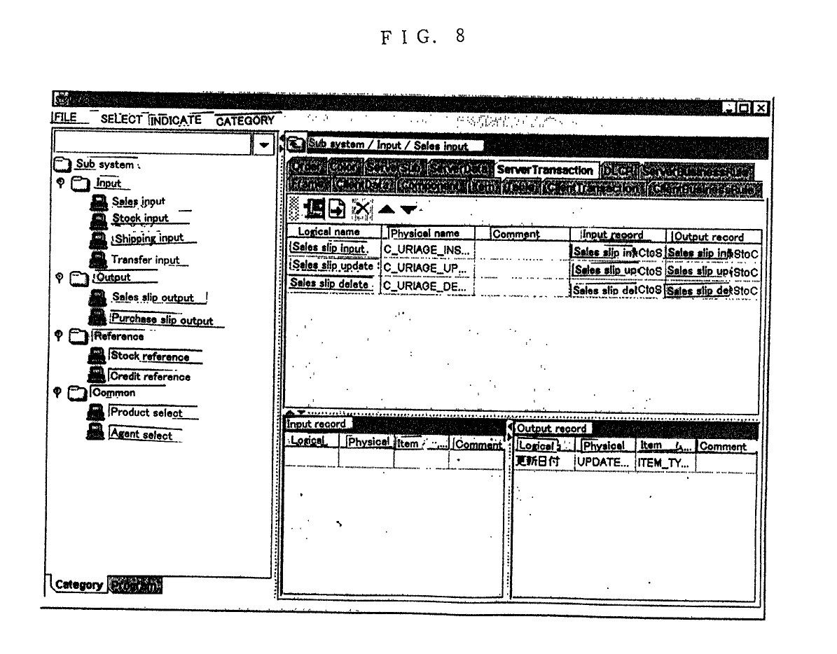

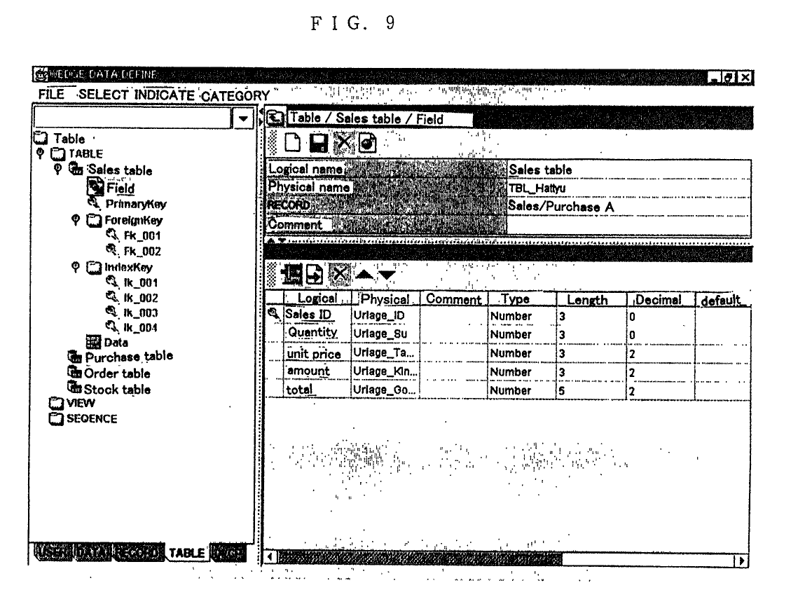

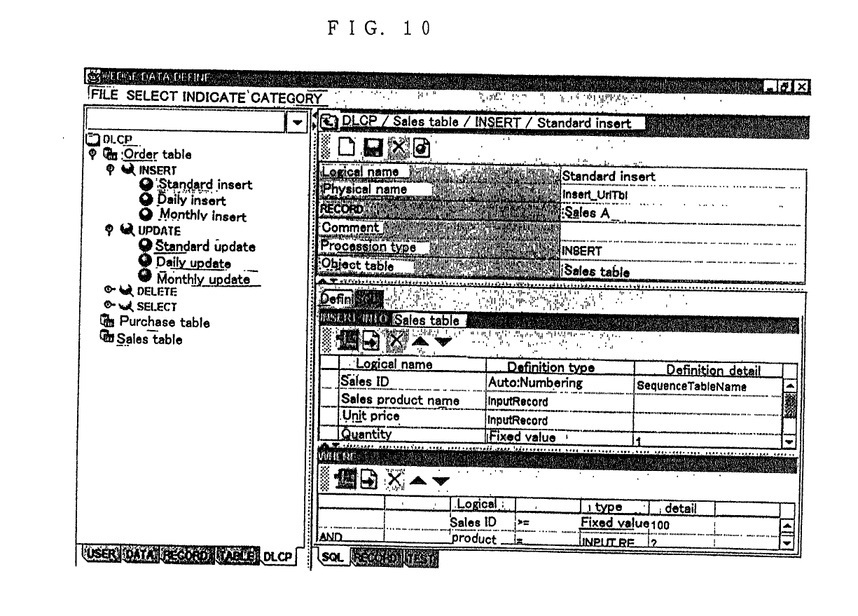

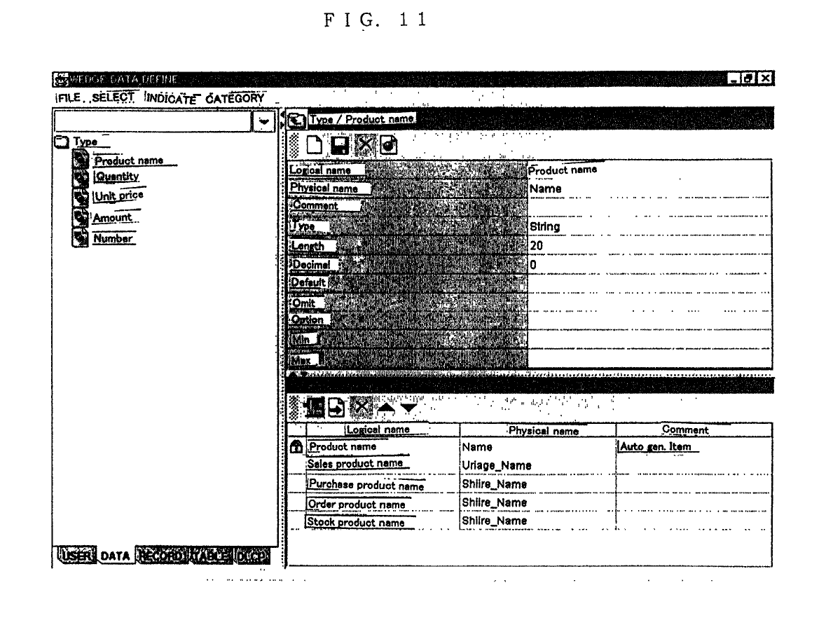

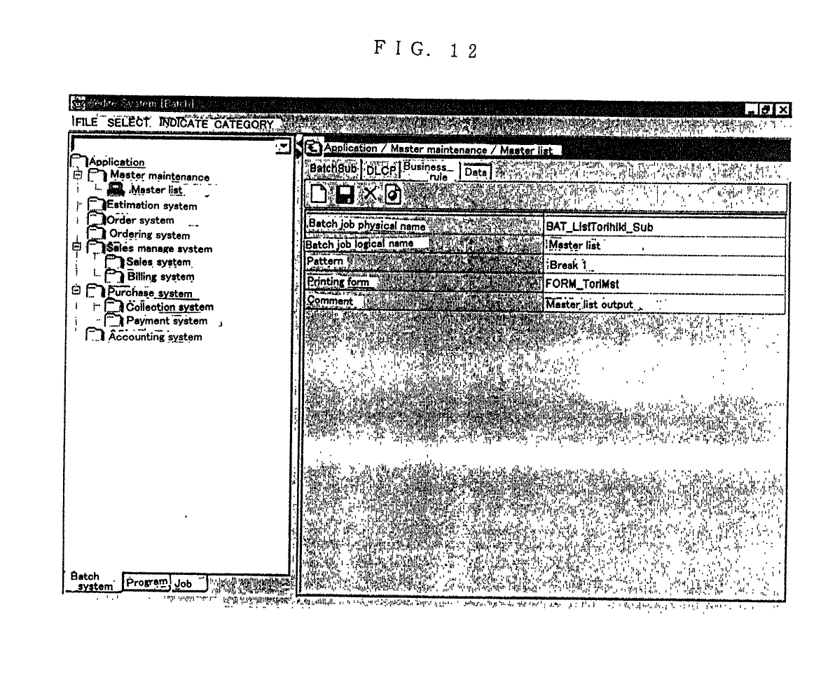

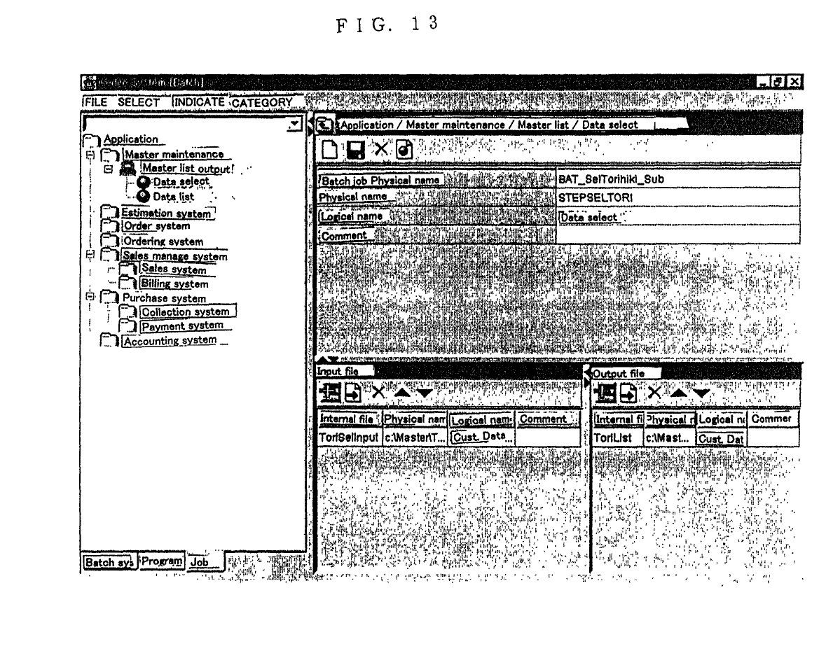

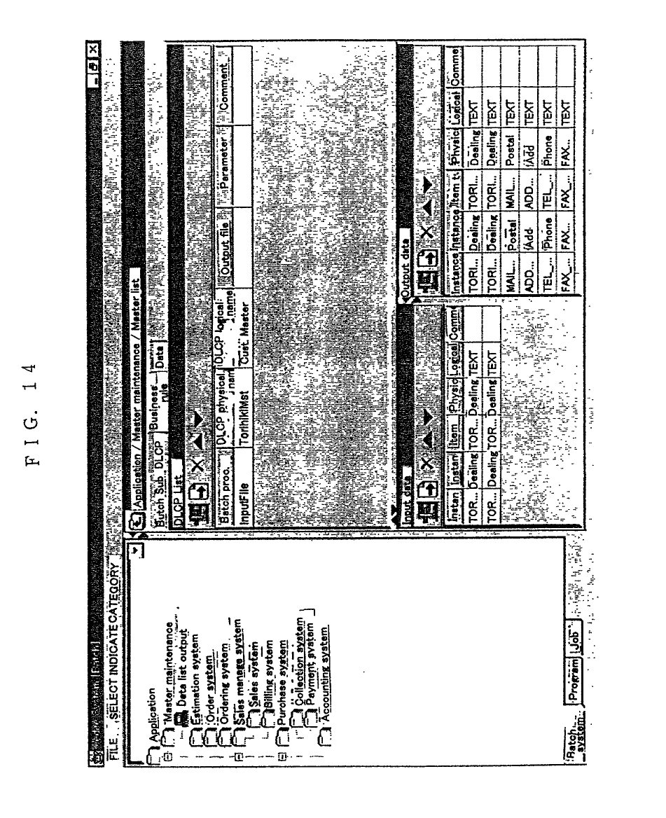

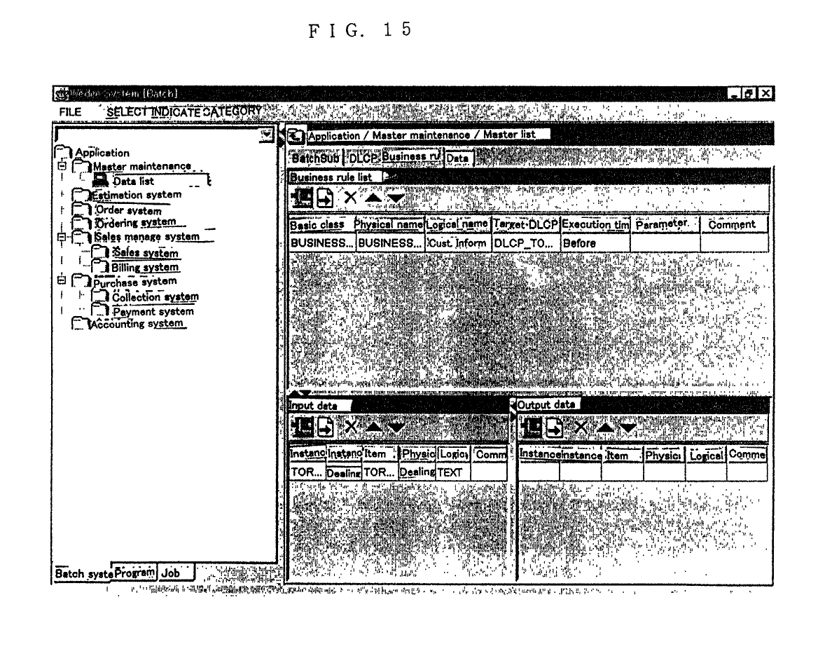

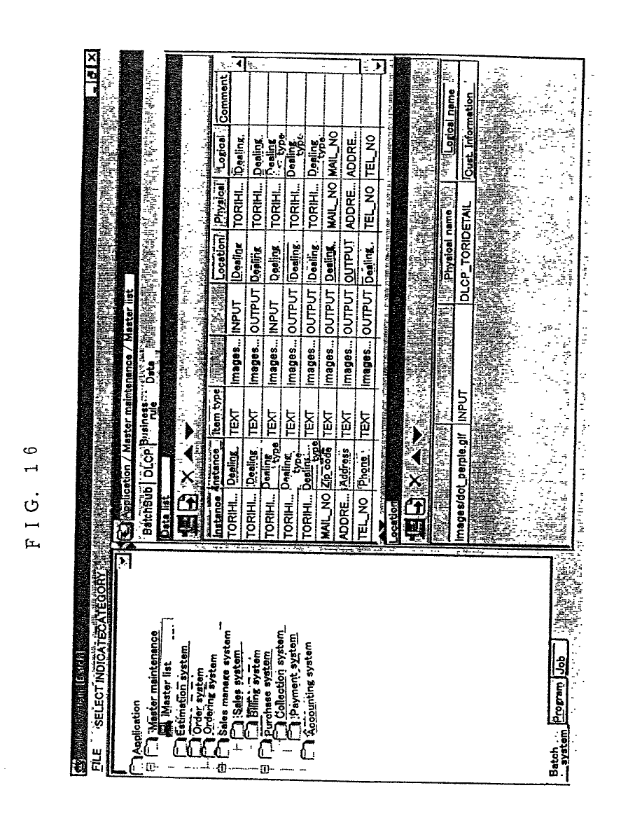

Also, when the engine program has been already downloaded in the client computer 20, or when the engine program is downloaded from server computer 10, the engine program is started (see step S220), and graphical input interfaces of the definition information, for example, shown in FIG. 7 through FIG. 17, are displayed on the display 25 of the client computer 20, so the definition information can be input corresponding to the desired data processing to be executed via the graphical input interfaces.

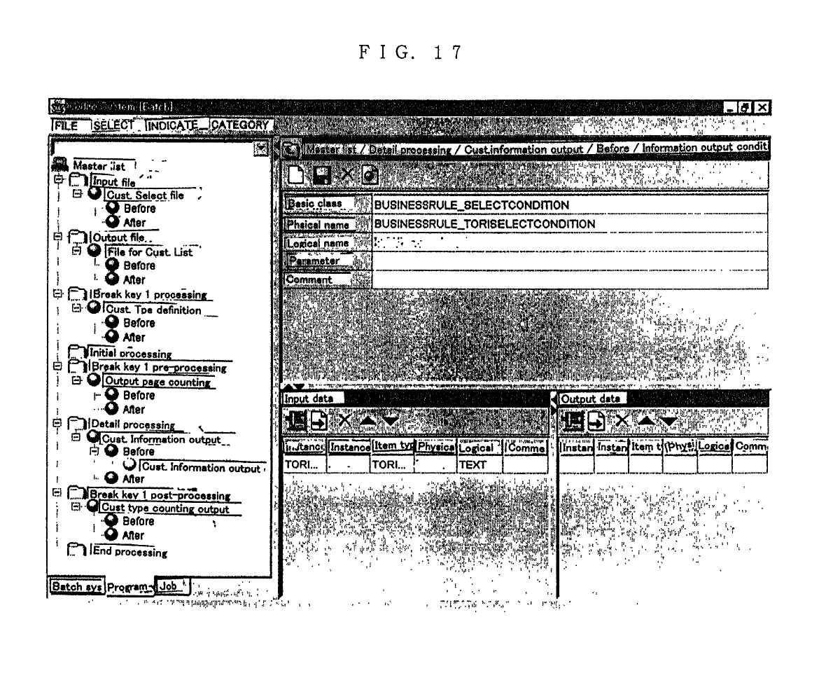

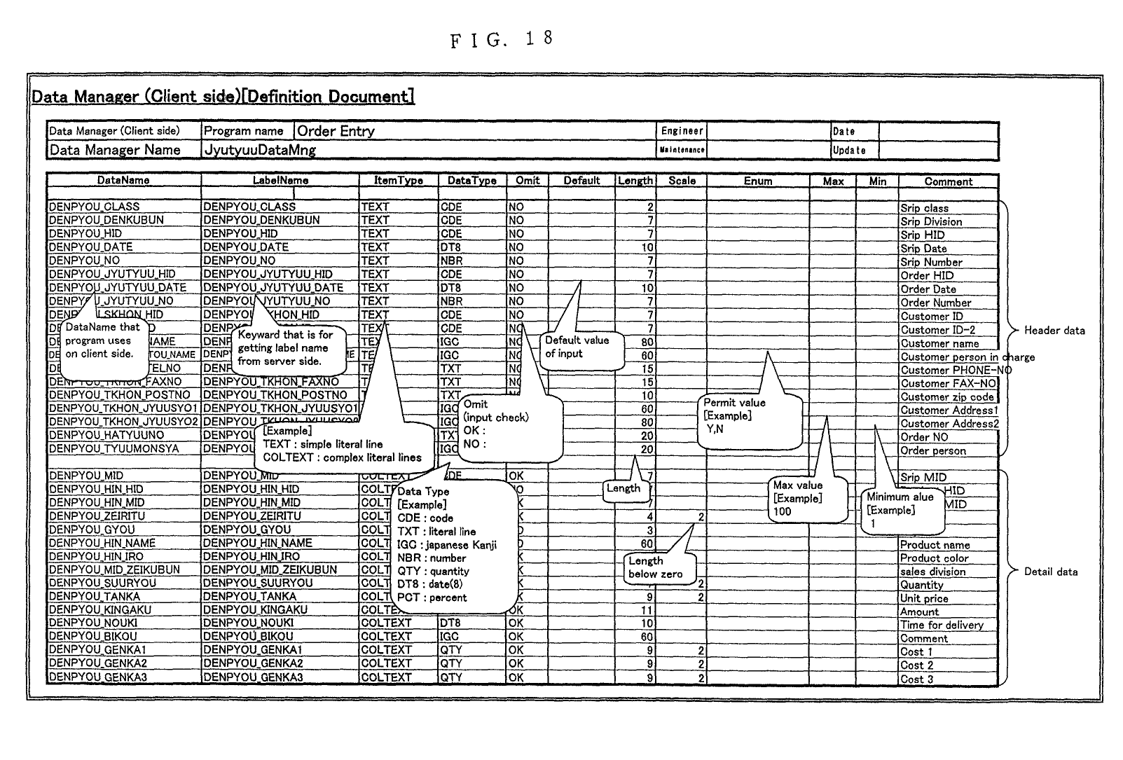

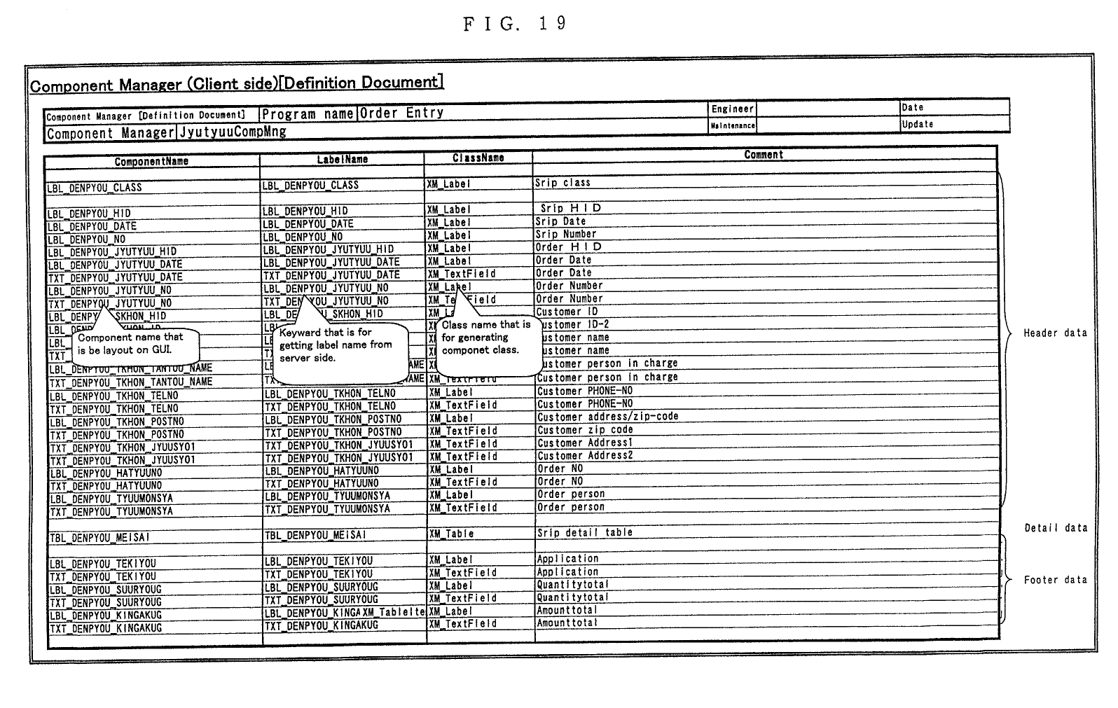

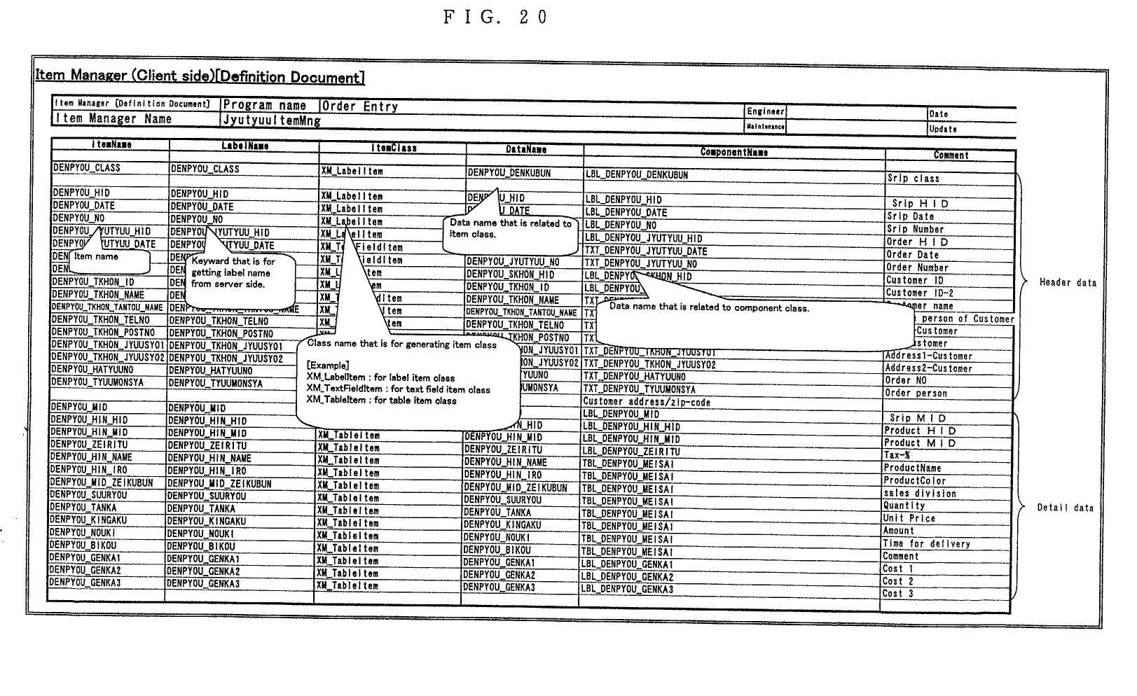

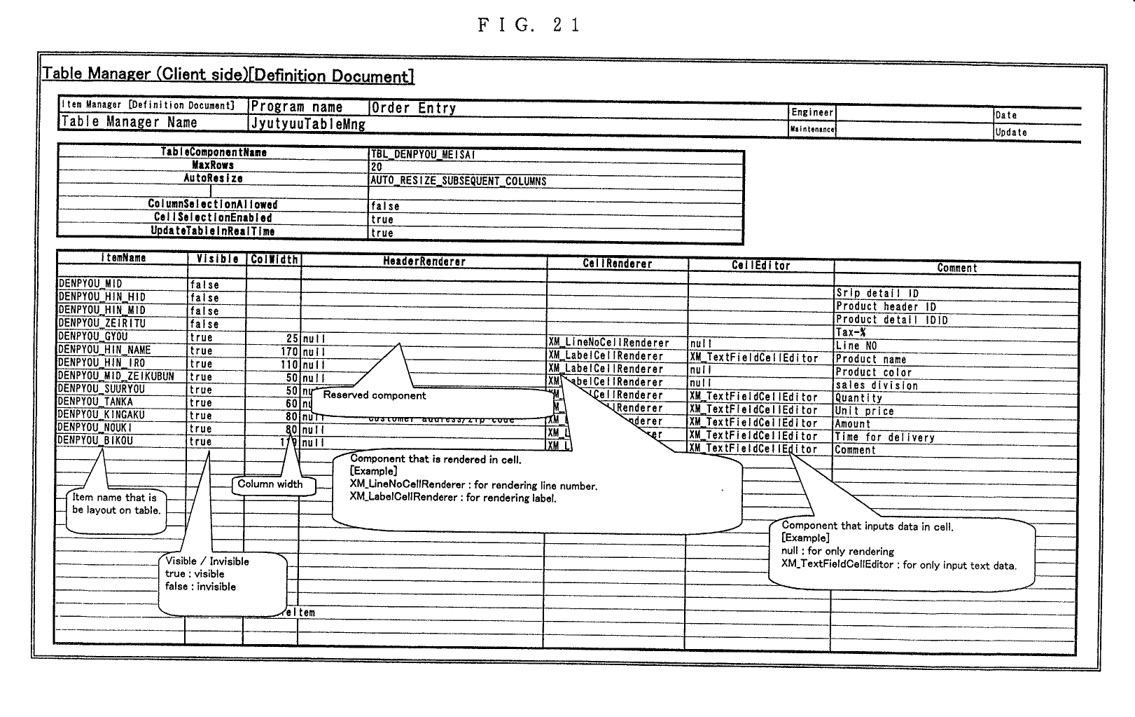

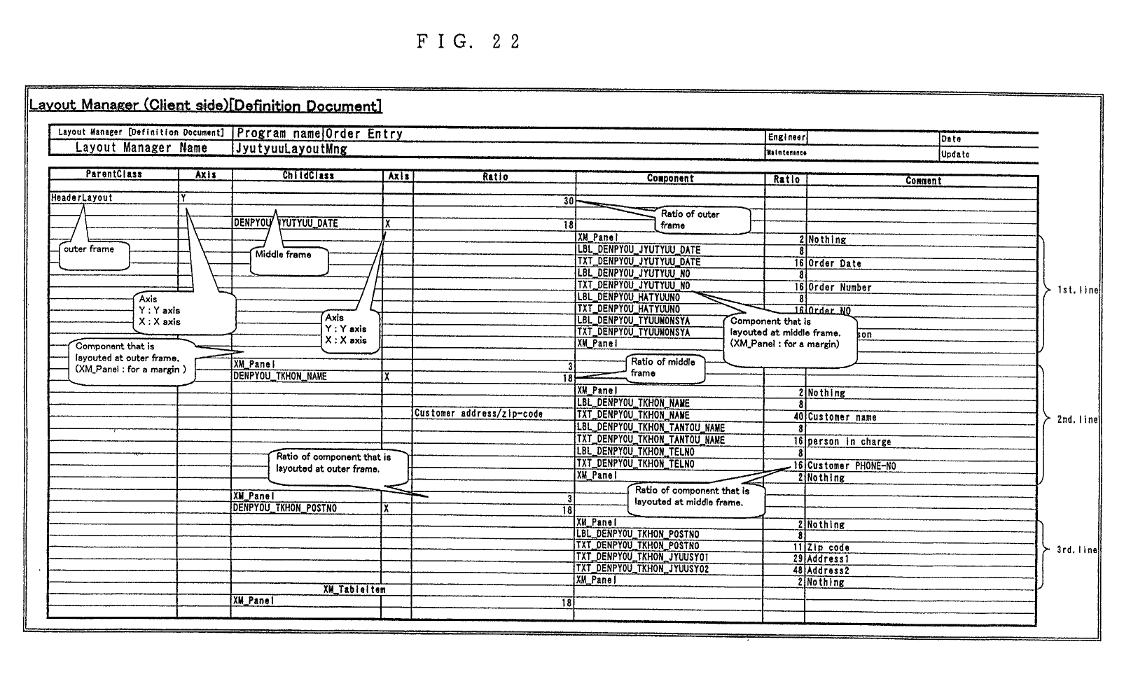

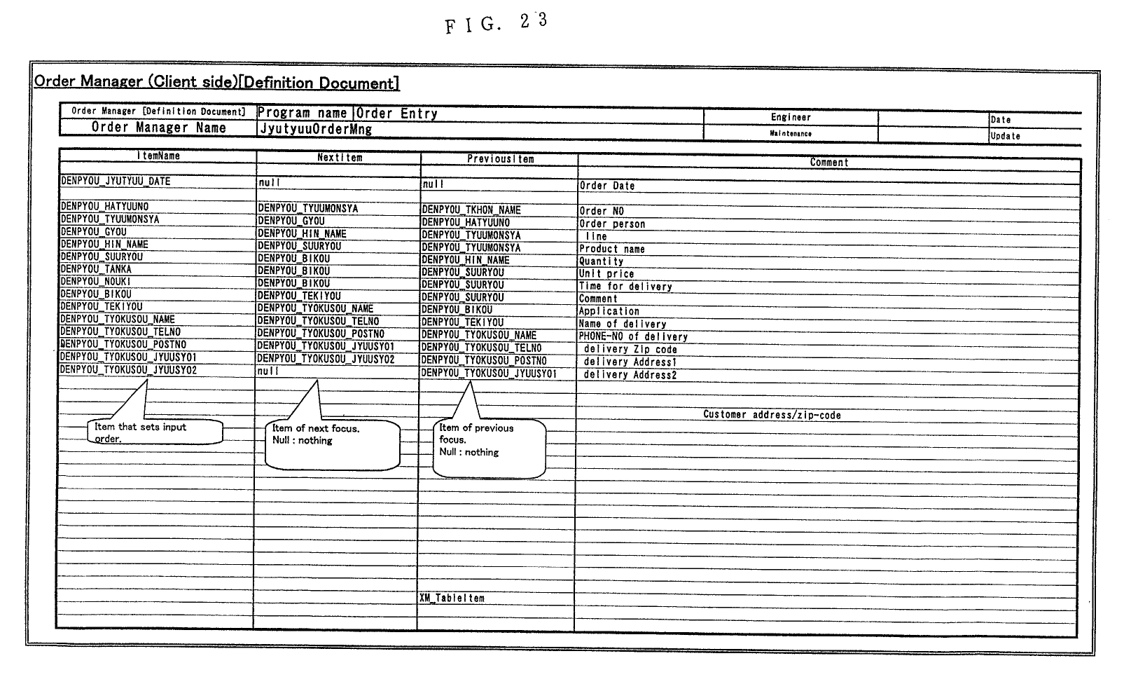

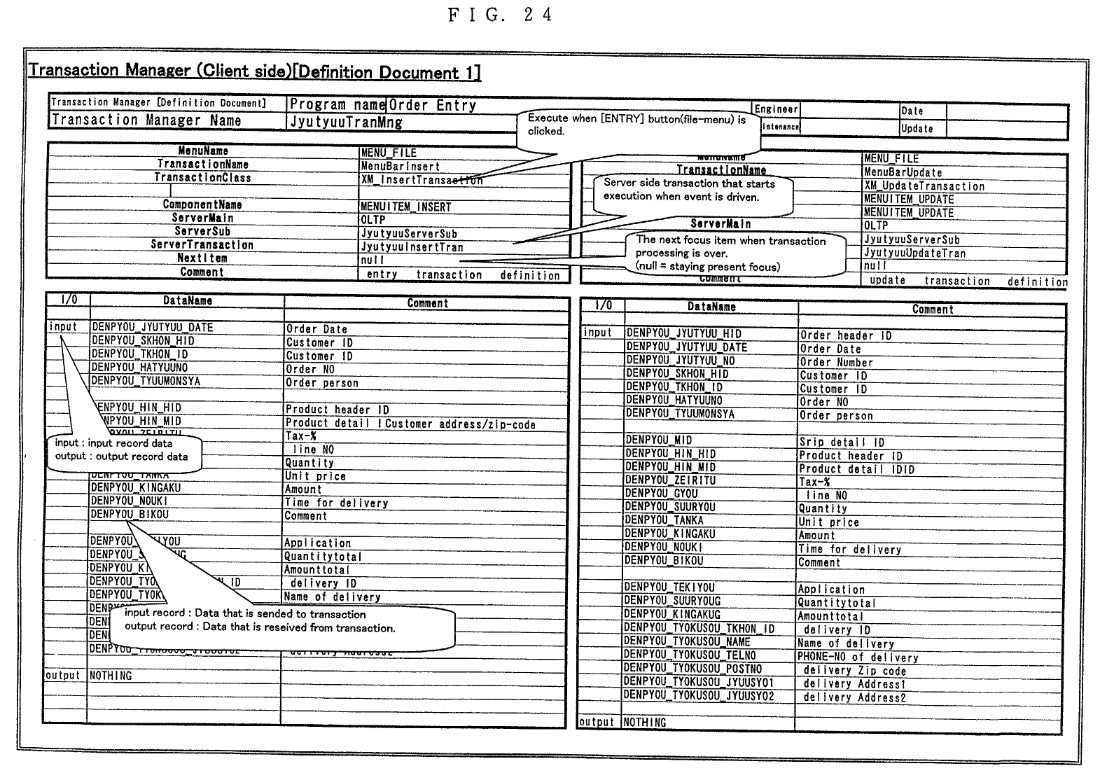

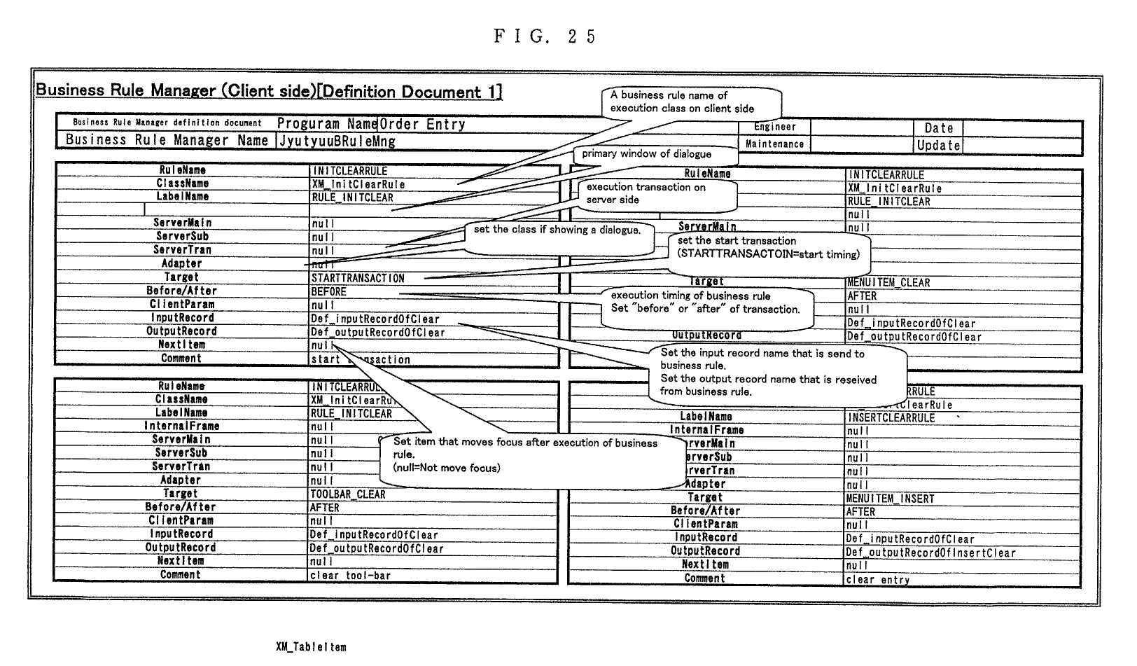

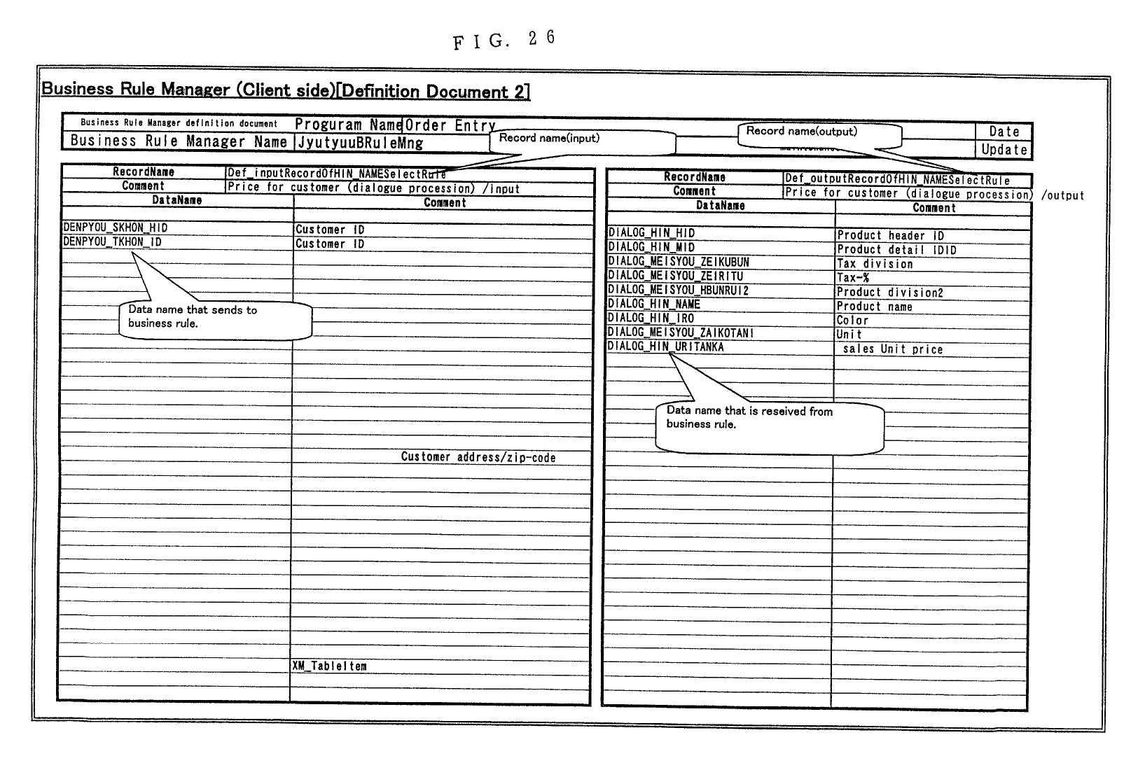

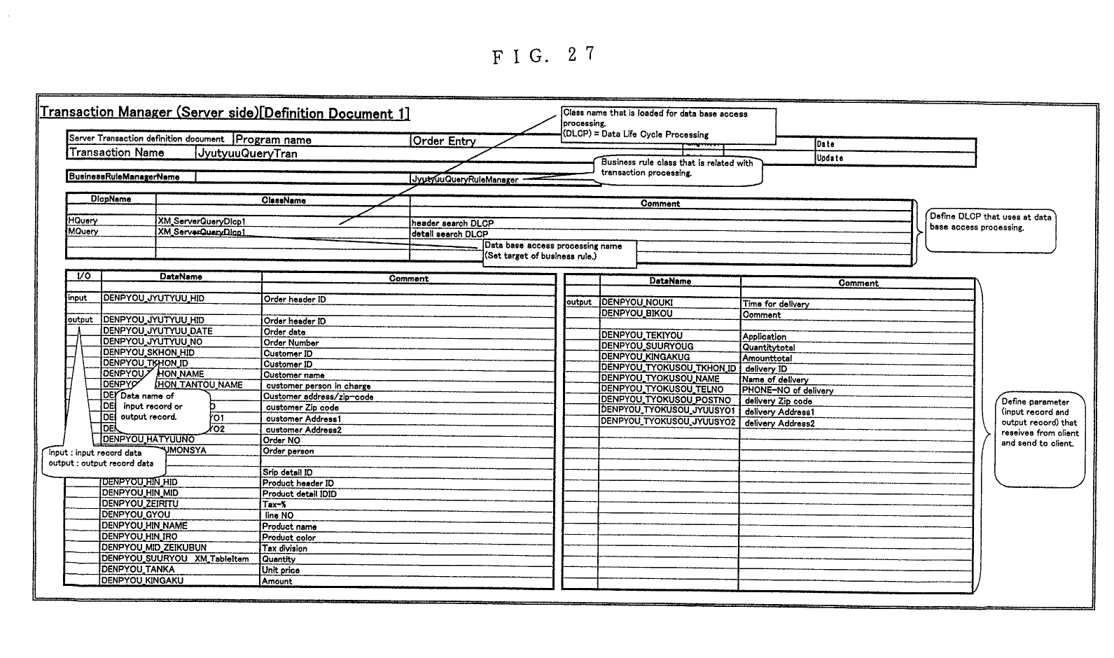

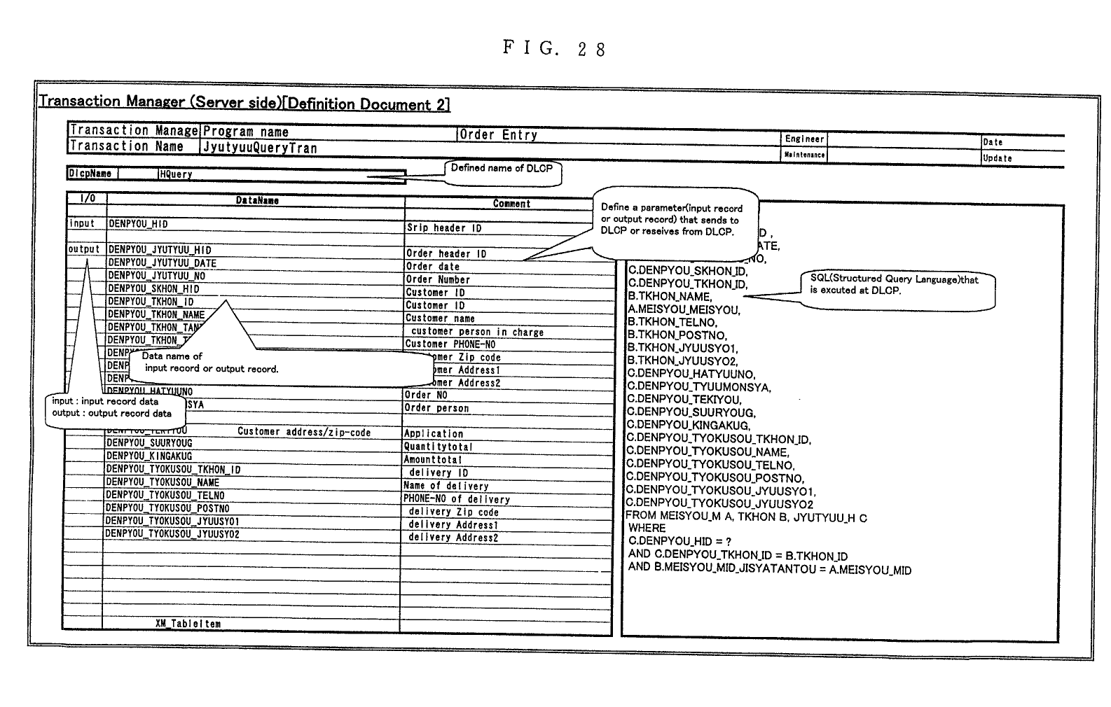

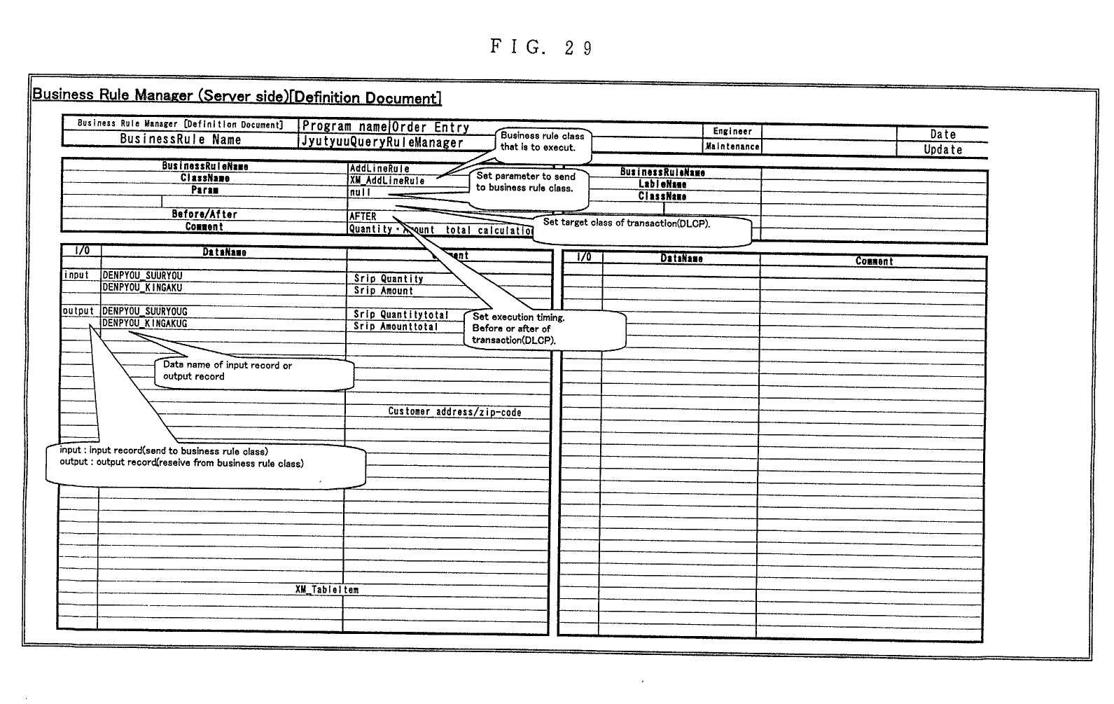

The definition information and the configuration information are defined with correspondence to each other. FIG. 17 through FIG. 29 show examples of the definition information. When an input operation of the definition information is done, the definition information is sent from the client computer 20 to the server computer 10 (see step S230).

When receiving the definition information, the server computer 10 reads out the configuration information corresponding to the definition information, and sends said configuration information to the client computer 20 (see step S110). And when receiving the configuration information, the client computer 20 analyzes the configuration information (see step S240), automatically calls the functional module classes corresponding to the configuration information. However, if the necessary functional module classes are not stored in the client computer 20, the client computer 20 requests the server computer 10 to download the necessary functional module classes (see step S250), and the server computer 10 transfers the necessary functional module classes to the client computer 20 (see step S120).

The client computer 20 dynamically generates a unit-program by using one or a plurality of the read or generated functional module classes (see step S260), and executes one or a plurality of the generated unit-program (see step S270). And the client computer 20 repeats said dynamical generation and execution of said one or a plurality of the unit-program, thereby the desired data processing is executed as a whole.

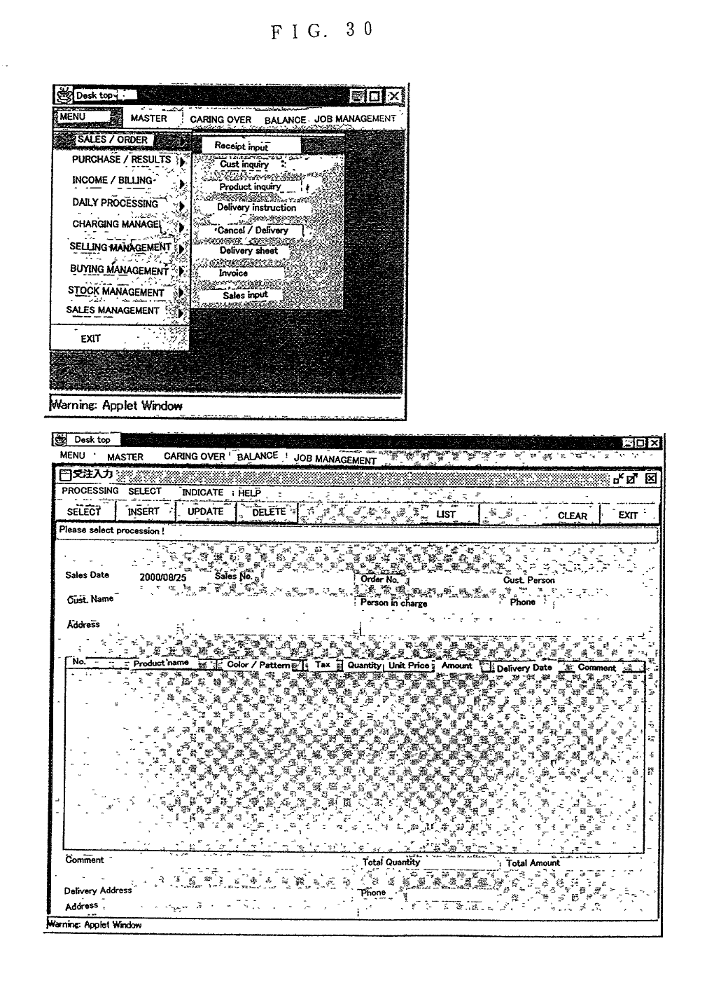

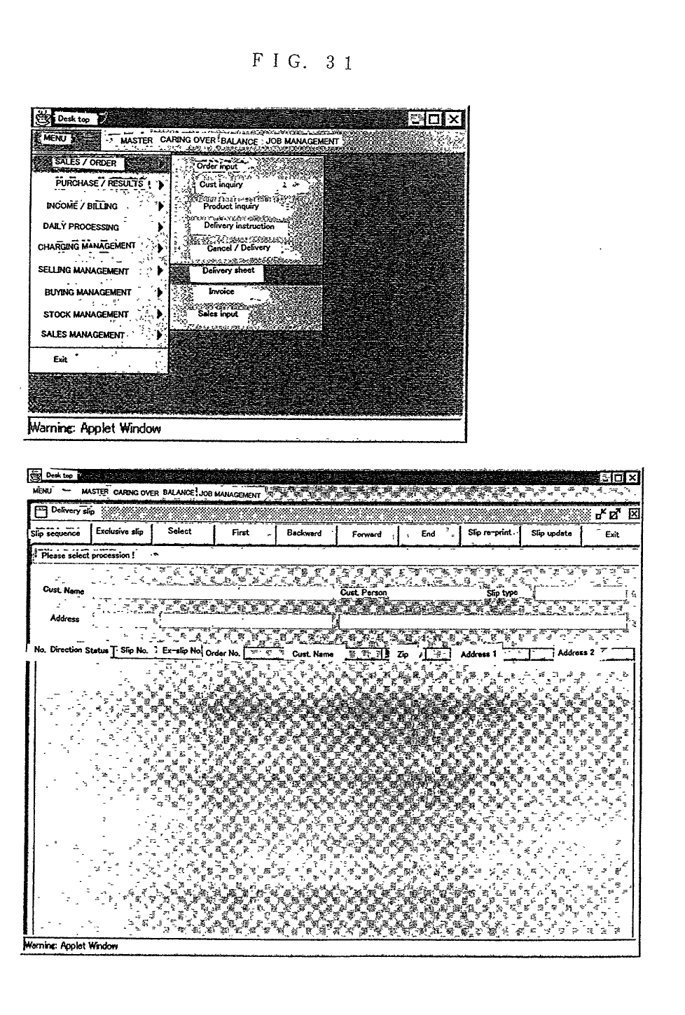

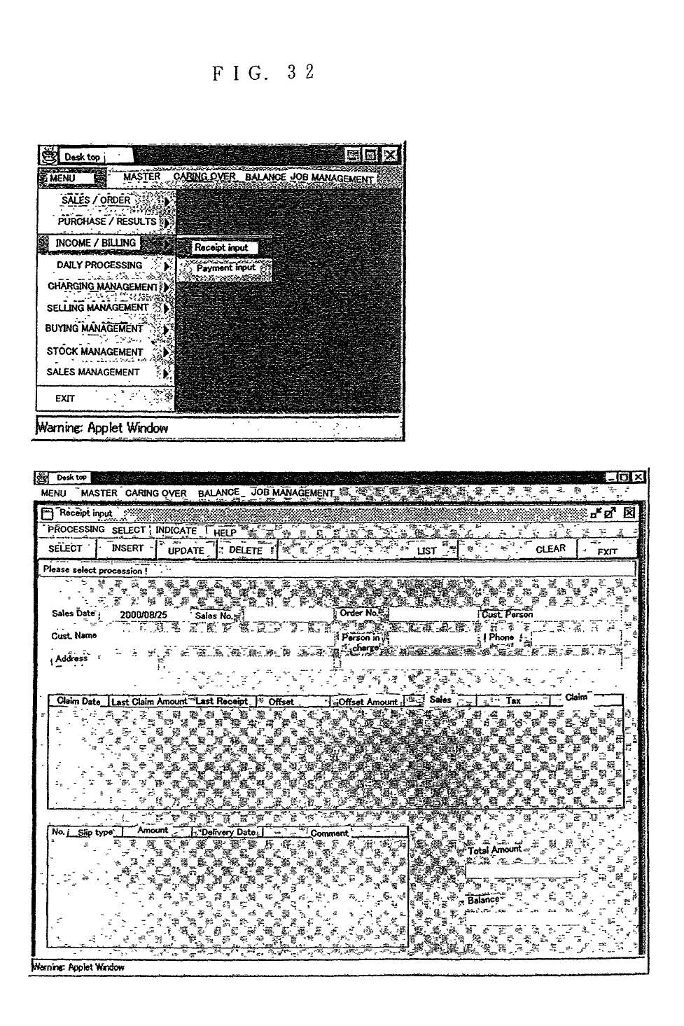

When said data processing is executed, for example, the display screens shown in FIG. 30 through FIG. 32 are displayed.

If the following identical data processing is started, since the server computer 10 stores one or a plurality of the configuration information that is used for generating the unit-program, when said desired data processing is selected and the execution thereof is ordered via the client computer 20, the request for the configuration information corresponding to the data processing is sent to the server computer 10 (see step S230), and the configuration information corresponding to said request is read out in the server computer 10 and then sent to the client computer 20 (see step S110). Thereafter, the same procedures of dynamically generating and processing as the first procedures are executed (see step S240-step S270).

If the data processing in the data processing server computer 30 is desired, the configuration information corresponding to the definition information is read out in the server computer 10, and then is sent to the data processing server computer 30 based on the definition information (see step S280, step S130 in FIG. 6), thereafter the data processing server computer 30 executes the same procedures as those of the client computer 20. That is, the data processing server computer 30 analyzes the configuration information, reads out the functional module classes, if necessary, is downloaded the functional module classes from the server computer 10, dynamically generates the unit-program processing by using one or a plurality of the functional module classes, executes one or a plurality of the generated unit-program (step S310), returns a result value of the data processing to the client computer 20 and/or the server computer 10 (see step S300-step S340), repeats said procedure. For example, various application data processing, various batch data processing, database access processing and other processing may be executed in the data processing server computer 30.

Also, the dynamic generation and execution of the unit-program may be distributed between the client computer 20 and the server computer 10 and/or the data processing server computer 30, and may be executed in each of computers 10, 20, 30.

Furthermore, it is possible that the necessary configuration information for processing the desired data processing in advance is stored in the server computer 10 corresponding to said data processing via the graphical user interfaces shown in FIG. 7 through FIG. 17 of the operator terminal computer of at least one of the server computer 10 and the client computer 20, only the request for the configuration information is sent from the client computer 20 to the server computer 10, and one or a plurality of unit-program is dynamically generated and processed.

It is to be understood that although the present invention has been described with regard to preferred embodiments thereof, various other embodiments and variants may occur to those skilled in the art, which are within the scope and spirit of the invention, and such other embodiments and variants are intended to be covered by the following claims.

The text of Japanese priority application no. 2000-302258 filed Oct. 2, 2000 is hereby incorporated by reference.

What is claimed is:

1. A system for dynamically generating and processing a program by connecting a server computer and at least one of a client computer and a data processing server computer via a network means, sending and receiving data therebetween, and executing a desired voluntary data processing process by dynamically generating and then processing at least one unit-program for data processing, said system comprising:
a functional module storage means for storing a plurality of functional module classes, wherein each of said functional module classes has a coded processing logic for processing at least a portion of the unit-program;
a configuration information storage means for storing a plurality of configuration information including at least request information to read out at least one of the functional module classes and a processing condition;
a definition information input means for inputting at least one definition information to declare the contents of a data processing process to be executed;
a configuration information read-out means for reading out at least one of the configuration information corresponding to said at least one of the definition information from said configuration information storage means;
a unit-program generating means for reading out at least one of the functional module classes corresponding to said at least one of the configuration information from said functional module storage means, wherein said unit-program generating means dynamically generates a unit-program by using the coded processing logic from said functional module classes; and
a unit-program processing means for dynamically executing said unit-program by using said processing condition included in said configuration information.

2. A system as defined in claim 1, further comprising a configuration information request means for requesting at least one of the configuration information for executing the data processing,
said configuration information storage means for storing the configuration information corresponding to the data processing to be executed, wherein said configuration information have been used for generating the data of the unit-program,
said configuration information read-out means reads out the configuration information from said configuration information storage means based on the request from said configuration information request means.

3. A system for dynamically generating and processing a program by connecting a server computer and a client computer via a network means, sending and receiving data therebetween, and executing the desired voluntary data processing process by dynamically generating and processing at least one unit-program for data processing, said system comprising:
a functional module storage means for storing a plurality of functional module classes, wherein each of said functional module classes comprises a coded processing logic for processing at least a portion of the unit-program;
a configuration information storage means for storing a plurality of configuration information corresponding to each of a plurality of data processing processes, wherein said configuration information includes at least request information to read out at least one of the functional module classes and a processing condition;
a configuration information request means for requesting at least one of the configuration information for executing the data processing process;
a configuration information read-out means for reading out at least one of the configuration information from said configuration information storage means corresponding to said request from the configuration information request means;
a unit-program generating means for reading out at least one of the functional module classes corresponding to said at least one of the configuration information from said functional module storage means, wherein said unit-program generating means dynamically generates a unit-program by using the coded processing logic from said functional module classes; and
a unit-program processing means for dynamically executing said unit-program based on said processing condition included in said configuration information.

4. A system as defined in claim 1, wherein said configuration information storage means stores at least one functional module class having a coded processing logic for handling at least one of a variable data and a parameter,
said definition information input means inputs at least one of definition information to declare the contents of the data processing process and at least one of the variable data and the parameter,
said configuration information read-out means reads out at least one of the configuration information from said configuration information storage means corresponding to said at least one of the definition information and the request from said configuration information request means, and
said unit-program generating means reads out at least one of the functional module classes including at least one functional module class from said functional module storage means corresponding to said at least one of the configuration information,
wherein the unit-program generating means dynamically generates the unit-program by using both the coded processing logic from said functional module classes and said at least one of the variable data and the parameter included in the configuration information.

5. A system as defined in claim 1, wherein said server computer comprises said configuration information storage means and said configuration information read-out means, said client computer comprises said functional module storage means, said unit-program generating means and said unit-program processing means.

6. A system as defined in claim 5, wherein said client computer further comprises said configuration information request means.

7. A system as defined in claim 5, wherein said server computer further comprises said functional module storage means, said unit-program generating means, said unit-program processing means and a processing result output means which returns a processing result of the unit-program to at least one of the client computer, the server computer and the data processing server computer.

8. A system as defined in claim 1, wherein said data processing server computer comprises said functional module storage means, said unit-program generating means and said unit-program processing means.

9. A system as defined in claim 1, wherein said definition information includes information relating to a combination of the functional module classes and a processing order of the functional module classes for executing the data processing process.

10. A client computer in a system for dynamically generating and processing a program by connecting to a server computer via a network means, sending and receiving data therebetween, and executing a desired voluntary data processing process by dynamically generating and processing at least one unit-program for a data processing process, said client computer comprising:
a functional module storage means for storing a plurality of functional module classes, wherein each of said functional module classes comprises a coded processing logic for processing at least a portion of the unit-program;
a definition information input means for inputting at least one definition information to declare the contents of a data processing process to be executed;
a unit-program generating means for reading out at least one of said functional module classes corresponding to at least one of the configuration information from said functional module storage means when said at least one of the configuration information including at least request information to read out at least one of said functional module classes and a processing condition are sent from the server computer, and then generating a unit-program by using the coded processing logic from said functional module classes; and
a unit-program processing means for dynamically executing said unit-program based on said processing condition included in said configuration information.

11. A client computer as defined in claim 10, wherein said server computer stores the configuration information used to generate the unit program corresponding to the data processing to be executed, said client computer further comprises a configuration information request means for requesting at least one of the configuration information corresponding to the data processing to be executed.

12. A client computer in a system for dynamically generating and processing a program by connecting to a server computer via a network means, sending and receiving data therebetween, and executing a desired voluntary data processing process by dynamically generating and processing at least one unit-program for data processing, said client computer comprising:
a functional module storage means for storing a plurality of functional module classes, wherein each of said functional module classes comprises a coded processing logic for processing at least a portion of the unit-program;
a configuration information request means for requesting configuration information to be sent to the client computer corresponding to the data processing to be executed;
a unit-program generating means for reading out at least one of said functional module classes corresponding to at least one of the configuration information from said functional module storage means when said configuration information including at least read-out information of said functional module class and a processing condition are sent from said server computer based on said request, and then generating the unit-program by using the coded processing logic from said functional module classes; and
a unit-program processing means for dynamically executing said unit-program based on said processing condition included in said configuration information.

13. A client computer as defined in claim 10, wherein said functional module storage means stores at least one functional module class having the coded processing logic for handling at least one of a variable data and a parameter,
said definition information input means inputs at least one of definition information to declare the contents of a data processing process to be executed and at least one of the variable data and the parameter, and
said unit-program generating means reads out at least one of said functional module classes including at least one functional module class for handling at least one of the variable data and the parameter corresponding to said at least one of the configuration information from said functional module storage means when said configuration information including at least information relating to the at least one functional module class based on said definition information or said request for sending the configuration information are sent from the server computer, and dynamically generating the unit-program by using both of the coded processing logic from said at least one functional module class and said at least one of the variable data and the parameter included in the configuration information.

14. A server computer in a system for dynamically generating and processing a program by connecting to at least one of a client computer and a data processing server computer via a network means, sending and receiving data therebetween, and making at least one of the client computer and the data processing server computer execute a desired voluntary data processing process by dynamically generating and processing at least one unit-program for data processing, said server computer comprising:
a configuration information storage means for storing a plurality of configuration information including at least request information to read out at least one functional module class and a processing condition, wherein each of the functional module classes comprises a coded processing logic for processing at least a portion of the unit-program; and
a configuration information read-out means for reading out at least one of the configuration information corresponding to at least one definition information from said configuration information storage means when said definition information declares the contents of a data processing process to be executed is sent from the client computer, sending and providing said read-out configuration information to at least one of the client computer and the data processing server computer,
whereby at least one of the client computer and the data processing server computer dynamically generates and processes at least one unit-program based on the processing condition included in the configuration information.

15. A server computer as defined in claim 14, wherein said configuration information storage means stores at least one of the configuration information which is used for generating said unit-program, corresponding to the data processing, and
said configuration information read-out means reads out at least one of the configuration information corresponding to said request for the configuration information sent from said client computer.

16. A server computer in a system for dynamically generating and processing a program by connecting to at least one of a client computer and a data processing server computer via a network means, sending and receiving data therebetween, and making at least one of the client computer and the data processing server computer execute a desired voluntary data processing process by dynamically generating and processing at least one unit-program for data processing, said server computer comprising:
a configuration information read-out means for reading out at least one of configuration information corresponding to a request which corresponds to a data processing to be executed from a configuration information storage means when said request to read out the configuration information is sent from the client computer, sending and providing said read-out configuration information to at least one of the client computer and the data processing server computer,
whereby at least one of the client computer and the data processing server computer dynamically generates and processes said unit-program based on a processing condition included in the configuration information.

17. A server computer as defined in claim 14, wherein said server computer further comprises:
a configuration information storage means for storing a plurality of configuration information coding the coded processing logic for processing at least a portion of the unit-program;
a unit-program generating means for reading out at least one of said functional module classes corresponding to the definition information from said functional module storage means when said definition information for declaring the contents of the data processing process to be executed are sent from said client computer, wherein said unit-program generating means dynamically generates the unit-program by using the coded processing logic from said functional module classes;
a unit-program processing means for dynamically executing said unit-program based on the processing condition included in said configuration information; and
a processing result output means for returning a processing result of the unit-program to at least one of the client computer and the data processing server computer.

18. A method for dynamically generating and processing a program by connecting a server computer and at least one of a client computer and a data processing server computer via a network means, sending and receiving data therebetween, and executing a desired voluntary data processing process by dynamically generating and processing at least one unit-program for data processing in at least one of the client computer and the data processing server computer, said method comprising the steps of:
storing a plurality of functional module classes into a functional module storage means and storing a plurality of configuration information into a configuration information storage means, wherein each of said functional module classes comprises a coded processing logic for processing at least a portion of a unit-program processing and said configuration information includes at least request information to read out at least one of the functional module classes and a processing condition;
inputting at least one definition information to declare the contents of a data processing to be executed via a definition information input means;
reading out at least one of the configuration information corresponding to said at least one of the definition information from said configuration information storage means via a configuration information read-out means;
reading out at least one of the functional module classes corresponding to said at least one of the configuration information from said functional module storage means via a unit-program generating means, and dynamically generating the unit-program program processing by using the coded processing logic from said functional module classes via said unit-program generating means; and
dynamically executing said unit-program of the data processing based on the processing condition included in said configuration information via a unit-program processing means.

19. A method as defined in claim 18, wherein said method further comprises the steps of:
storing the configuration information corresponding to the data processing to be executed into said configuration information storage means wherein said configuration information is used for generating the data of the unit-program, requesting at least one of the configuration information for executing the data processing via a configuration information request means, and
reading out the configuration information from said configuration information storage means based on the request of said configuration information request means via the configuration information read-out means.

20. A method for dynamically generating and processing a program by connecting a server computer and at least one of a client computer and a data processing server computer via a network means, sending and receiving data therebetween, and executing a desired voluntary data processing process by dynamically generating and processing at least one unit-program for data processing in at least one of the client computer and the data processing server computer, said method comprising the steps of:
storing a plurality of functional module classes into a functional module storage means and storing a plurality of configuration information into a configuration information storage means, wherein each of said functional module classes comprises a coded processing logic for processing at least a portion of a unit-program and said configuration information includes at least request information to read out at least one of said functional module classes and a processing condition;
sending the configuration information corresponding to contents of a data processing to be executed via a configuration information request means;
reading out at least one of the configuration information corresponding to said request from said configuration information storage means via a configuration information read-out means;
reading out at least one of said functional module classes corresponding to said at least one of configuration information from said functional module storage means via a unit-program generating means, and dynamically generating the unit-program processing by using the coded processing logic of said functional module classes via said unit-program generating means; and
dynamically executing said unit-program processing based on the processing condition included in said configuration information via a unit-program processing means.

21. A computer-readable and -recordable media for controlling at least one of a client computer and a data processing server computer comprising a system for dynamically generating and processing a program by connecting a server computer and at least one of the client computer and the data processing server computer via a network means, sending and receiving data therebetween, and executing a desired voluntary data processing process by dynamically generating and processing at least one unit-program for data processing in at least one of the client computer and the data processing server computer, said media comprising:
a controlling program for storing a plurality of functional module classes having a coded processing logic;
a controlling program for reading out at least one of said functional module classes and for dynamically generating a unit5 program processing by using the coded processing logic of said functional module classes; and
a controlling program for dynamically executing said unit-program processing based on a processing condition included in said configuration information.

22. A computer-readable and -recordable media for controlling at least one of a client computer and a data processing server computer comprising a system for dynamically generating and processing a program by connecting a server computer and at least one of the client computer and the data processing server computer via a network means, sending and receiving data therebetween, and executing a desired voluntary data processing process by dynamically generating and processing at least one unit-program for data processing in at least one of the client computer and the data processing server computer, said recordable media comprising:
a controlling program for storing a plurality of configuration information including at least one functional module read-out information and a processing condition, wherein a plurality of functional module classes code a logic of a data processing process to be executed;
a controlling program for reading out the configuration information and for sending the read-out configuration information to at least one of the client computer and the data processing server computer when definition information to declare the contents of the data processing process to be executed is sent from the client computer;
a controlling program for storing the configuration information including a read-out information for reading out said functional module classes that code the logic of the data processing; and
a controlling program for reading out the configuration information and for sending the read-out configuration information to at least one of the client computer and the data processing server computer when the definition information to declare the contents of the data processing process to be executed are sent from the client computer.

23. A computer-readable and -recordable media as defined in claim 22, wherein said media further comprises a controlling program for storing at least one of configuration information corresponding to the data processing to be executed, said configuration information is used for generating a unit-program processing, and a controlling program for reading out at least one of the configuration information based on request information for reading out the configuration information corresponding to the data processing to be executed when said request is sent from the client computer.

24. A computer-readable and -recordable media for controlling at least one of a client computer and a data processing server computer comprising a system for dynamically generating and processing a program by connecting a server computer and at least one of the client computer and the data processing server computer via a network means, sending and receiving data therebetween, and executing a desired voluntary data processing process by dynamically generating and processing at least one unit-program for data processing in at least one of the client computer and the data processing server computer, said media comprising:
a controlling program for storing a plurality of functional module classes having a coded process logic;
a controlling program for outputting a request of the configuration information corresponding to a data processing to be executed;
a controlling program for reading out at least one of said functional module classes and for dynamically generating a unit-program processing by using the coded processing logic of said functional module classes when the configuration information including at least functional module read-out information and a processing condition are sent from said server computer; and
a controlling program for dynamically executing said unit-program of data processing based on the processing condition included in said configuration information.

25. A computer-readable and -recordable media for controlling a server computer comprising a system for dynamically generating and processing a program by connecting a server computer and at least one of the client computer and the data processing server computer via a network means, sending and receiving data therebetween, and executing a desired voluntary data processing process by dynamically generating and processing at least one unit-program for data processing in at least one of the client computer and the data processing server computer, said media comprising:
a controlling program for storing configuration information including at least functional module read-out information corresponding to a data processing and a processing condition, wherein a plurality of functional module classes code a logic of the data processing; and
a controlling program for reading out the configuration information and for sending the read-out configuration information to at least one of the client computer and the data processing server computer when a request for the configuration information corresponding to the data processing to be executed are sent from the client computer.

26. A program transfer system for transferring and downloading a controlling program to at least one of a client computer and a data processing server computer comprising a system for dynamically generating and processing a program by connecting a server computer and at least one of the client computer and the data processing server computer via a network means, sending and receiving data therebetween, and executing a desired voluntary data processing process, said program transfer system comprising:
a program storage means for storing a controlling program for storing a plurality of functional module classes having a coded processing logic, a controlling program for reading out at least one of said functional module classes when definition information is provided to the server computer and the configuration information including at least functional module read-out information to declare the contents of a data processing process to be executed and a processing condition are sent from the server computer, and for dynamically generating a unit-program processing by using the coded processing logic of said functional module classes, and a controlling program for dynamically executing said unit-program of data processing based on the processing condition included in said configuration information;
a program read-out means for reading out the controlling program from said program storage means based on a request from at least one of the client computer and the data processing server computer; and
a transfer means for transferring said read-out controlling program to at least one of the client computer and the data processing server computer.

27. A program transfer system as defined in claim 26, wherein said program storage means stores a controlling program which stores at least one of the configuration information corresponding to the data processing to be executed, said configuration information is used for generating the unit-program processing, and reads out at least one of the configuration information based on a request for reading out the configuration information corresponding to the data processing to be executed when said request is sent from the client computer.

28. A program transfer system for transferring and downloading a controlling program to at least one of a client computer and a data processing server computer comprising a system for dynamically generating and processing a program by connecting a server computer and at least one of the client computer and the data processing server computer via a network means, sending and receiving data therebetween, and executing a desired voluntary data processing process, said program transfer system comprising:
a program storage means for storing a controlling program for storing a plurality of functional module classes having a coded processing logic, a controlling program for outputting a request for at least one of configuration information corresponding to a data processing to be executed, a controlling program for reading out at least one of said functional module classes when the configuration information including at least functional module read-out information and a processing condition are sent from the server computer and for dynamically generating a unit-program processing by using the coded processing logic of said functional module classes, and a controlling program for dynamically executing said unit-program processing based on the processing condition included in said configuration information;
a program read-out means for reading out the controlling program from said program storage means based on a request from at least one of the client computer and the data processing server computer; and
a transfer means for transferring said read-out controlling program to at least one of the client computer and the data processing server computer via the network means.

29. A program transfer system as defined in claim 26, wherein said server computer comprises said program storage means, said program read-out means and said transfer means.
